(19) United States
(12) Patent Application Publication
(10) Pub. No.: US 2016/0091910 A1
(43) Pub. Date: Mar. 31, 2016

(54) VOLTAGE GENERATION CIRCUIT

(71) Applicant: SHARP KABUSHIKI KAISHA, Osaka-shi, Osaka (JP)

(72) Inventor: Yoshiteru ISHIMARU, Osaka-shi (JP)

(73) Assignee: SHARP KABUSHIKI KAISHA, Osaka-shi, Osaka (JP)

(21) Appl. No.: 14/892,253

(22) PCT Filed: Jun. 11, 2014
(86) PCT No.: PCT/JP2014/065491

§ 371 Date: Nov. 19, 2015

(30) Foreign Application Priority Data
Jun. 27, 2013 (JP) 2013-135116

(51) Int. Cl. G05F 1/56

(52) U.S. Cl. CPC G05F 1/56

(57) ABSTRACT

In a first circuit 118, a voltage obtained by a summation of a forward junction voltage of base-emitter junction of a transistor 103 and a voltage drop due to a resistor 107 is generated between a first terminal and a second terminal in accordance with an emitter current of the transistor 103 and is applied to a collector terminal of a first bipolar transistor 108. In a second circuit 109, a forward junction voltage of base-emitter junction is generated between a first terminal connected to a terminal 116 and a second terminal connected to a base terminal of the transistor 108 in accordance with the emitter current and is applied to the base terminal of the first bipolar transistor 108.

### TECHNICAL FIELD

The present invention relates to a voltage generation circuit having small dependency on power supply voltage.

### BACKGROUND ART

For example, a voltage generation circuit described in PTL 1 has been proposed as the voltage generation circuit in the related art. FIG. 18 is a circuit diagram of an example of the voltage generation circuit in the related art. As illustrated in FIG. 18, a voltage generation circuit 51 is a circuit in which transistors 52 and 53 are connected with resistors 54 and 55. In the voltage generation circuit 51, when a voltage is applied to a power supply terminal 56, summation of base-emitter voltages (Vbe) in the transistors 52 and 53, that is, an output voltage of twice Vbe is output to a voltage output terminal 57. The voltage generation circuit 51 has properties that “a voltage generated in the voltage output terminal becomes higher as a power supply voltage becomes higher” and has dependency, which is not small, of the output voltage on the power supply voltage.

A circuit which causes such dependency of the output voltage on the power supply voltage to be reduced will be described with reference to the accompanying drawings. FIG. 19 is a circuit diagram of another example of the voltage generation circuit in the related art. A voltage generation circuit 61 illustrated in FIG. 19 is obtained by adding a resistor 62 between a base terminal of the transistor 52 and the voltage output terminal 57 in the voltage generation circuit 51. Other than that, the voltage generation circuit 61 illustrated in FIG. 19 has a configuration similar to the voltage generation circuit 51, and substantially the same elements and terminals are denoted by the same reference signs.

In the voltage generation circuit 61, an action of voltage drop due to the resistor 62 causes an effect of “decreasing a voltage generated in the voltage output terminal in accordance with an increase of the power supply voltage” to occur. Thus, a portion of properties of the voltage generation circuit 51, that is, the properties of “the voltage generated in the voltage output terminal increasing in accordance with an increase of the power supply voltage” is negated. It is possible to reduce power supply voltage dependency of an output voltage by this effect of the resistor 62. Alternatively, characteristics of the voltage generation circuit 61 may be adjusted such that an output voltage has the maximum value at the power supply voltage having a certain value and the output voltage turns to decreasing at the power supply voltage having a value equal to or more than the certain value. That is, the voltage generation circuit 61 is a circuit having reduced power supply voltage dependency of the output voltage in comparison to the voltage generation circuit 51. Particularly, the voltage generation circuit 61 becomes an excellent circuit which can be used as a voltage generation circuit having significantly small dependency on power supply voltage by using the circuit in the vicinity of the power supply voltage which causes the output voltage to have the maximum value.

A relationship between the output voltage and the power supply voltage in each of the voltage generation circuits 51 and 61 will be described below. FIG. 20 is a diagram illustrating the relationship between the output voltage and the power supply voltage in each of the voltage generation circuits illustrated in FIGS. 18 and 19. In FIG. 20, a graph curve 71 is a graph indicating the relationship between the output voltage (vertical axis) and the power supply voltage (horizontal axis) in the voltage generation circuit 51. A graph curve 72 is a graph indicating the relationship between the output voltage (vertical axis) and the power supply voltage (horizontal axis) in the voltage generation circuit 61. The graph curves 71 and 72 are calculated by performing circuit simulation for the output voltages of the voltage generation circuits 51 and 61.

Regarding a resistance value of each resistor in the simulation, the resistor 54 is set to 3200Ω, the resistor 55 is set to 8000Ω, and the resistor 62 (only in the voltage generation circuit 61) is set to 50Ω. The transistors 52 and 53 are set to be GaAs hetero-junction bipolar transistors and to have a size of an emitter being 48 μm².

As illustrated in FIG. 20, the output voltage (graph curve 71) of the voltage generation circuit 51 gradually increases in accordance with an increase of the power supply voltage. That is, it is found that the voltage generation circuit 51 is a circuit having high power supply voltage dependency of an output voltage. On the other hand, the output voltage (graph curve 72) of the voltage generation circuit 61 increases in accordance with an increase of the power supply voltage. However, the output voltage has the maximum value when the power supply voltage has a value of about 4 V, and then the output voltage is decreased in accordance with the increase of the power supply voltage. That is, when the voltage generation circuit 61 is used with a power supply voltage having a value of the vicinity of 4 V, the voltage generation circuit 61 may be used as a voltage generation circuit having significantly-low power supply voltage dependency.

In the voltage generation circuit 61 illustrated in FIG. 19, a resistance value of the resistor 62 is changed and thus the power supply voltage which causes the output voltage to have the maximum value can be changed. In FIG. 20, a graph curve 73 is a graph illustrating a relationship between the output voltage and the power supply voltage when the resistor 62 of the voltage generation circuit 61 is changed to be 100Ω. A graph curve 74 is a graph illustrating a relationship between the output voltage and the power supply voltage when the resistor 62 of the voltage generation circuit 61 is set to 150 Ω.

As illustrated in the graph curves 72, 73, and 74 of FIG. 20, the power supply voltage which causes the output voltage to have the maximum value is moved to a low power supply voltage region as a resistance value of the resistor 61 is increased. Thus, in the voltage generation circuit 61, adjustment may be performed such that a “power supply voltage range in which the power supply voltage dependency is small” is provided on the low power supply voltage region.

### CITATION LIST

### Patent Literature

PTL 1: Japanese Patent No. 3847756

### SUMMARY OF INVENTION

### Technical Problem

However, as “the power supply voltage causing the output voltage to have the maximum value is moved to the low power supply voltage region”, a “power supply voltage range in which the power supply voltage dependency is small” of the output voltage becomes narrower and an output voltage value which is the maximum value is decreased.

Here, the output voltage value may be adjusted by changing element values of other circuit elements. FIG. 21 is a diagram illustrating a relationship between the output voltage and the power supply voltage when the resistors and the transistors in the voltage generation circuit illustrated in FIGS. 18 and 19 are changed.

FIG. 21 illustrates an output voltage when the output voltage is adjusted by changing an element size of the transistor 52 in the voltage generation circuit 61 such that the output voltage at a time of the power supply voltage of 3 V is the same as the output voltage (graph curve 71) of the voltage generation circuit 51. Results obtained by respectively adjusting the size of the transistor 52 to be 0.74 times, 0.53 times, and 0.4 times the original size regarding the resistance values 50 Ω, 100Ω, and 150Ω of the resistor 62 are illustrated as graph curves 82, 83, and 84. It is clearly shown that, even when the output voltage is adjusted, the output voltage on a high power supply voltage region is decreased more and the “power supply voltage range in which the power supply voltage dependency is small” becomes narrower as the power supply voltage causing the output voltage to have the maximum value is set to be on the low power supply voltage region.

For example, it is preferable to have characteristics in that the output voltage is not changed at the power supply voltage as low as possible such that the output voltage only slightly fluctuates even when the power supply voltage is decreased due to, for example, consumption of a battery. However, in this case, the power supply voltage dependency on the high power supply voltage region is greatly deteriorated.

The resistor 54 and the resistor 55 may be set to be small, and thus the output voltage may be changed in a direction in which the output voltage increases. However, it is difficult to suppress deterioration of the power supply voltage dependency at the high power supply voltage and to improve the power supply voltage dependency at the low power supply voltage.

An object of the present invention is to provide a voltage generation circuit which has a simple configuration, has improved power supply voltage dependency when the power supply voltage is a low voltage, and has low power supply voltage dependency in a wide power supply voltage range.

### Solution to Problem

To achieve the above object, the present invention provides a voltage generation circuit which includes a first power supply terminal, a voltage output terminal, a first resistor, a first bipolar transistor, a second bipolar transistor, a first circuit, and a second circuit. A first terminal of the first resistor is connected to the first power supply terminal. An emitter terminal of the first bipolar transistor is connected to a ground terminal. A first terminal of the first circuit is connected to a second terminal of the first resistor. A second terminal of the first circuit is connected to a collector terminal of the first bipolar transistor. The first circuit is one of two circuits: a circuit which has a diode and a resistor, and generates a voltage obtained by a summation of a forward junction voltage of diode junction and voltage drop due to the resistor, between the first terminal of the first circuit and the second terminal of the first circuit, in accordance with a diode current, and a circuit which has a bipolar transistor and a resistor, and generates a voltage obtained by a summation of a forward junction voltage of base-emitter junction and voltage drop due to the resistor, between the first terminal of the first circuit and the second terminal of the first circuit, in accordance with an emitter current. A first terminal of the second circuit is connected to a second terminal of the first resistor. A second terminal of the second circuit is connected to a base terminal of the first bipolar transistor. The second circuit is one of two circuits: a circuit which has a diode, and generates a forward junction voltage of diode junction between the first terminal of the second circuit and the second terminal of the second circuit in accordance with a diode current, and a circuit which has a bipolar transistor, and generates a forward junction voltage of base-emitter junction between the first terminal of the second circuit and the second terminal of the second circuit in accordance with an emitter current. An emitter terminal of the second bipolar transistor is connected to the ground terminal. A collector terminal of the second bipolar transistor is connected to the base terminal of the first bipolar transistor. A base terminal of the second bipolar transistor is connected to the second terminal of the first circuit. The base-emitter junction of the first bipolar transistor and the base-emitter junction of the second bipolar transistor are connected in a forward direction for a potential at the first power supply terminal. The voltage output terminal is directly connected to the second terminal of the first resistor or is connected to the second terminal of the first resistor through a resistor.

### Advantageous Effects of Invention

According to the present invention, it is possible to provide a voltage generation circuit which has a simple configuration, has improved power supply voltage dependency when the power supply voltage is a low voltage, and has low power supply voltage dependency in a wide power supply voltage range.

### BRIEF DESCRIPTION OF DRAWINGS

FIG. 1 is a circuit diagram illustrating an example of a voltage generation circuit according to the present invention.

FIG. 2 is a diagram illustrating a relationship between an output voltage and a power supply voltage in the voltage generation circuit illustrated in FIG. 1.

FIG. 3 is a diagram illustrating a first circuit.

FIG. 4A is a diagram illustrating another example of a second circuit.

FIG. 4B is a diagram illustrating another example of a second circuit.

FIG. 4C is a diagram illustrating another example of a second circuit.

FIG. 4D is a diagram illustrating another example of a second circuit.

FIG. 5 is a circuit diagram illustrating another example of the voltage generation circuit according to the present invention.

FIG. 6 is a diagram illustrating a relationship between an output voltage and a power supply voltage in the voltage generation circuit illustrated in FIG. 5.

FIG. 7 is a diagram illustrating a relationship between a current of each component and the power supply voltage in the voltage generation circuit illustrated in FIG. 5.

FIG. 8 is a circuit diagram illustrating yet another example of the voltage generation circuit according to the present invention.

FIG. 9 is a diagram illustrating a relationship between the output voltage and the power supply voltage in the voltage generation circuit illustrated in FIG. 8.

FIG. 10 is a diagram illustrating a relationship between a current of each component and the power supply voltage in the voltage generation circuit illustrated in FIG. 8.

FIG. 11A is a circuit diagram illustrating yet another example of the voltage generation circuit according to the present invention.

FIG. 11B is a circuit diagram illustrating yet another example of the voltage generation circuit according to the present invention.

FIG. 12 is a diagram illustrating a relationship between the output voltage and the power supply voltage in each of the voltage generation circuits illustrated in FIGS. 11A and 11B.

FIG. 13A is a circuit diagram illustrating yet another example of the voltage generation circuit according to the present invention.

FIG. 13B is a circuit diagram illustrating a replaceable circuit of the voltage generation circuit illustrated in FIG. 13A.

FIG. 14 is a diagram illustrating a relationship between the output voltage and the power supply voltage in the voltage generation circuit according to the present invention.

FIG. 15 is a circuit diagram illustrating yet another example of the voltage generation circuit according to the present invention.

FIG. 16A is a diagram illustrating a relationship between the output voltage and the power supply voltage in the voltage generation circuit according to the present invention.

FIG. 16B is a diagram illustrating the relationship between the output voltage and the power supply voltage in the voltage generation circuit illustrated in FIG. 1.

FIG. 17 is a diagram illustrating an example of a high frequency power amplification circuit using the voltage generation circuit according to the present invention.

FIG. 18 is a circuit diagram illustrating an example of the voltage generation circuit in the related art.

FIG. 19 is a circuit diagram illustrating another example of the voltage generation circuit in the related art.

FIG. 20 is a diagram illustrating a relationship between an output voltage and a power supply voltage in the voltage generation circuit illustrated in FIGS. 18 and 19.

FIG. 21 is a diagram illustrating a relationship between an output voltage and a power supply voltage when a resistor and a transistor in the voltage generation circuit illustrated in FIGS. 18 and 19 are changed.

### DESCRIPTION OF EMBODIMENTS

Hereinafter, embodiments according to the present invention will be described with reference to the accompanying drawings. In the following embodiments, a circuit configuration example in which a power supply voltage applied to a power supply terminal has a positive value and NPN type bipolar transistors are included will be described. However, it is not limited thereto. For example, the similar circuit configuration may be obtained by using PNP type bipolar transistors and the similar effects may be obtained by the power supply voltage and an output voltage having a negative value. In that case, in the subsequent descriptions, when values of the voltage or values of the current are compared, such values are taken as absolute values of the voltage or absolute values of the current, and an anode terminal and a cathode terminal in electrodes of a diode are considered reversely.

In the following embodiments, parts and terminals of the same configuration are denoted by the same reference signs. Thus, the drawings illustrating characteristics illustrates results obtained by simulation calculation, by applying the same element value to components having the same symbols unless otherwise described. When there is no particular description, GaAs hetero-junction bipolar transistors having a size of an emitter area of 48 μm² are used as transistors. When transistors having different sizes are used, an emitter area of each of the transistors is represented by a ratio to the size (48 μm²).

### First Embodiment

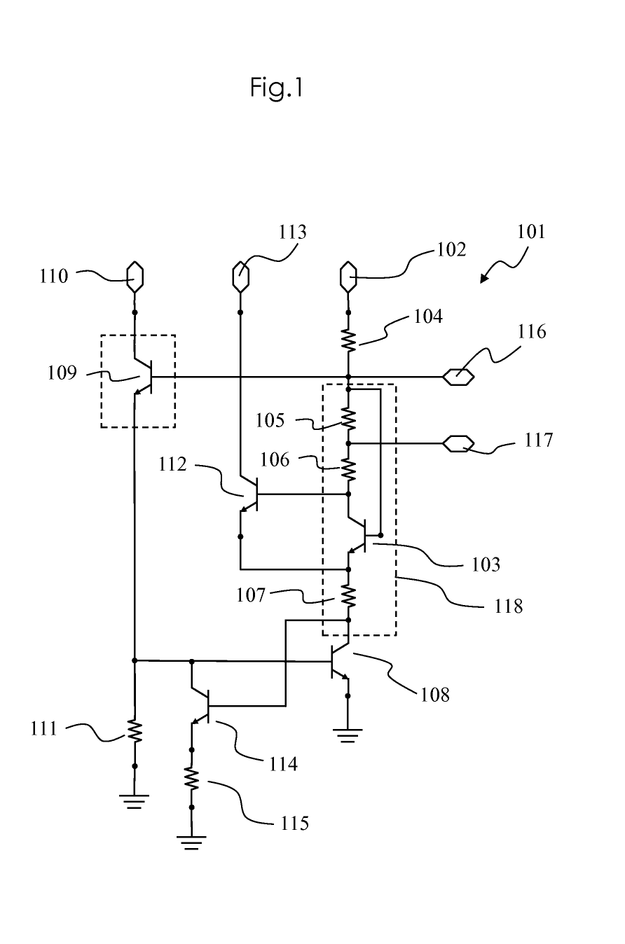

FIG. 1 is a circuit diagram illustrating a configuration of an example of a voltage generation circuit according to a first embodiment. As illustrated in FIG. 1, in a voltage generation circuit 101, a power supply terminal 102 and a base terminal of a transistor 103 are connected to each other through a resistor 104. A base terminal of the transistor 103 is connected to a collector terminal of the transistor 103 through resistors 105 and 106. An emitter terminal of the transistor 103 is connected to a collector terminal of a transistor 108 through a resistor 107.

An emitter terminal of the transistor 108 is grounded, and a base terminal of the transistor 108 is connected to an emitter terminal of a transistor 109. A base terminal of the transistor 109 is connected to a power supply terminal 102 through the resistor 104. A collector terminal of the transistor 109 is connected to a power supply terminal 110 and an emitter terminal of the transistor 109 is connected to a ground terminal through a resistor 111.

A base terminal of a transistor 112 is connected to the collector terminal of the transistor 103, and an emitter terminal of the transistor 112 is connected to the emitter terminal of the transistor 103. A collector terminal of the transistor 112 is connected to a power supply terminal 113. A base terminal of a transistor 114 is connected to a collector terminal of the transistor 108, and a collector terminal of the transistor 114 is connected to the base terminal of the transistor 108. An emitter terminal of the transistor 114 is grounded through a resistor 115. A terminal 116 connected to the base terminal of the transistor 109 or a terminal 117 connected between the resistors 105 and 106 is set as a power output terminal.

Here, the power supply terminal 102 is a first power supply terminal and the power supply terminals 113 and 110 are power supply terminals having the same potential as the first power supply terminal.

The resistor 104 is a first resistor and the transistor 108 is a first bipolar transistor. The transistor 103 of which a base and a collector are connected to each other through the resistors 105 and 106, and a resistor 107 constitute a first circuit 118 indicated by a dashed line.

The first circuit 118 has a configuration in which a summation of a forward junction voltage of base-emitter junction of the transistor 103 and voltage drop due to the resistor 107 is generated between a first terminal connected to the terminal 116 and a second terminal connected to the collector terminal of the transistor 108 in accordance with an emitter current of the transistor 103.

The transistor 109 is a second circuit and the second circuit has a configuration in which a forward junction voltage of base-emitter junction is generated between a first terminal connected to the terminal 116 (first terminal of the first circuit) and a second terminal connected to the base terminal of the transistor 108 in accordance with an emitter current thereof.

The transistor 114 is a second bipolar transistor and the transistor 103 is a third bipolar transistor. The transistor 112 is a fourth bipolar transistor.

A path from the base terminal of the transistor 103 to the collector terminal of the transistor 103 through the resistors 105 and 106 is a first connection path. In the voltage generation circuit 101, a connection point between the base terminal of the transistor 103 and the resistor 105 is a first connection terminal on the first connection path.

An emitter terminal of the transistor 112 is connected to a path from the emitter terminal of the transistor 103 to the collector terminal of the transistor 108 through the resistor 107. In the voltage generation circuit 101, the emitter terminal of the transistor 112 is connected to the emitter terminal of the transistor 103.

A base terminal of the transistor 112 is connected to a first path between the first connection terminal and the collector terminal of the transistor 103. The resistors 105 and 106 are provided between the base terminal of the transistor 112 and the first connection terminal.

In the following descriptions, in order to demonstrate an operation of the voltage generation circuit 101, simulation is performed by using a model of the circuit configuration in FIG. 1, and thus a value of an output voltage and the like is calculated. In the simulation, the resistor 104 is set as 3200Ω, the resistor 105 is set as 45Ω, and the resistor 106 is set as 155Ω. The resistor 107 is set as 200Ω, the resistor 111 is set as 8000Ω, and the resistor 115 is set as 20Ω. All of power supply voltages applied to all of the power supply terminals 102, 110, and 113 are set to have the same voltage.

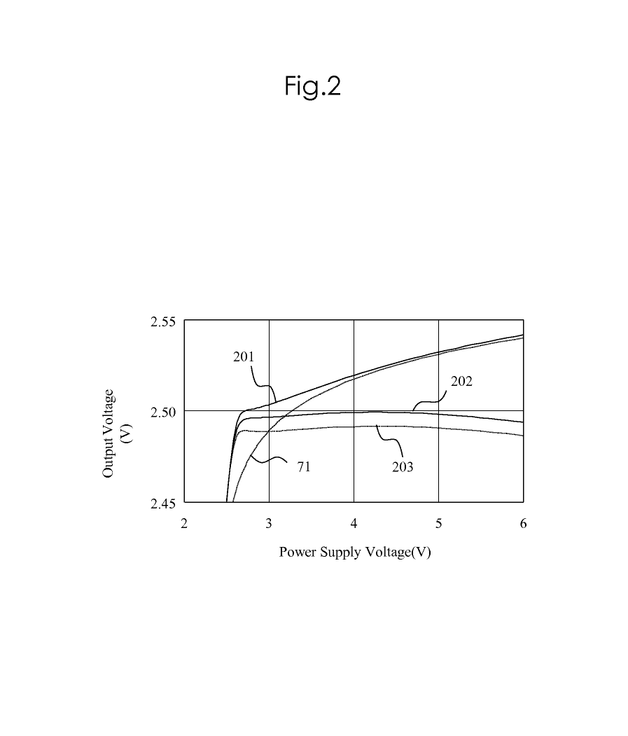

FIG. 2 is a diagram illustrating a relationship between an output voltage and a power supply voltage in the voltage generation circuit according to the present invention.

In the graph of FIG. 2, a graph curve 201 is a graph illustrating the relationship between an output voltage and a power supply voltage in the voltage generation circuit 101 when the terminal 116 is used as a voltage output terminal. A graph curve 202 illustrates a relationship between an output voltage and a power supply voltage in the circuit 101 when the terminal 117 is used as the voltage output terminal. A graph curve 203 illustrates a relationship between an output voltage and a power supply voltage in the voltage generation circuit 101 when a resistance value of the resistor 111 is set to 11000Ω. This resistance value of the resistor 111 is adjusted so as to cause an output voltage of the terminal 117 to be the same output voltage as the voltage generation circuit 51 in the related art when the power supply voltage is 3 V. In the graphs of FIG. 2, a graph curve 71 illustrating a relationship between the output voltage and the power supply voltage in the voltage generation circuit 51 of the related art is illustrated as a comparison target.

As illustrated in the graph curve 71 of FIG. 2, the output voltage of the voltage generation circuit 51 in the related art increases with a gradual gentle slope with an increase of the power supply voltage. Conversely, “if the power supply voltage is decreased, the slope becomes greater and thus the output voltage is reduced”. As illustrated in the graph curve 201, the output voltage at a low power supply voltage when the terminal 116 of the voltage generation circuit 101 is set as the voltage output terminal is higher than the output voltage (graph curve 71) of the voltage generation circuit 51 in the related art. Thus, characteristics that the slope becomes greater as the power supply voltage is decreased, and thus the output voltage is reduced are improved, and the slope when the power supply voltage is higher than about 2.7 V becomes substantially a straight line.

As illustrated in the graph curve 202, the output voltage when the terminal 117 of the voltage generation circuit 101 is used as the voltage output terminal becomes constant in a range in which the power supply voltage is higher than about 2.7 V.

The voltage generation circuit according to the present invention has a purpose of improving the power supply voltage dependency of the output voltage, and particularly, improving the power supply voltage dependency of the output voltage by increasing the output voltage at the low power supply voltage. Accordingly, there is a case where if the output voltage is high, the output voltage at low power supply voltage region is increased, and thus it seems to achieve the improvement. In addition, there is a case where if a value of the resistor 104 or the resistor 111 is decreased, a current of the circuit greatly increases and thus it seems to enable improvement in comparison to a case where the current of the circuit is small. Thus, when comparison is performed, the resistor 104 which is the first resistor is set to 3200Ω so as to be the same as the resistor 54 of the voltage generation circuit 51 in the related art and the resistor 111 is also set to be not less than 8000Ω of the resistor 55 of the circuit 51 in the related art. Then, the characteristics are compared.

A graph of a result obtained by adjusting the element value to cause the output voltage at the power supply voltage of 3 V to be the same as that in a comparison circuit is also illustrated, and thus the characteristics are confirmed. In a case of the first embodiment, as illustrated in the graph curve 203, it is possible to confirm that the power supply voltage dependency in the voltage generation circuit 101 (model for comparing the power supply voltage dependency of the output voltage) with more accuracy obtained by changing the value of the resistor 111 is smaller than the power supply voltage dependency of the output voltage of the voltage generation circuit 51 in the related art, in a wide power supply voltage range.

In the voltage generation circuit according to the present invention, since the power supply voltage dependency in a low voltage range is improved by temporarily increasing the current of the circuit in a low power supply voltage region, all consumed currents in the circuit may be not increased and the scope of the present invention is not limited thereto by the consumed currents in the circuit.

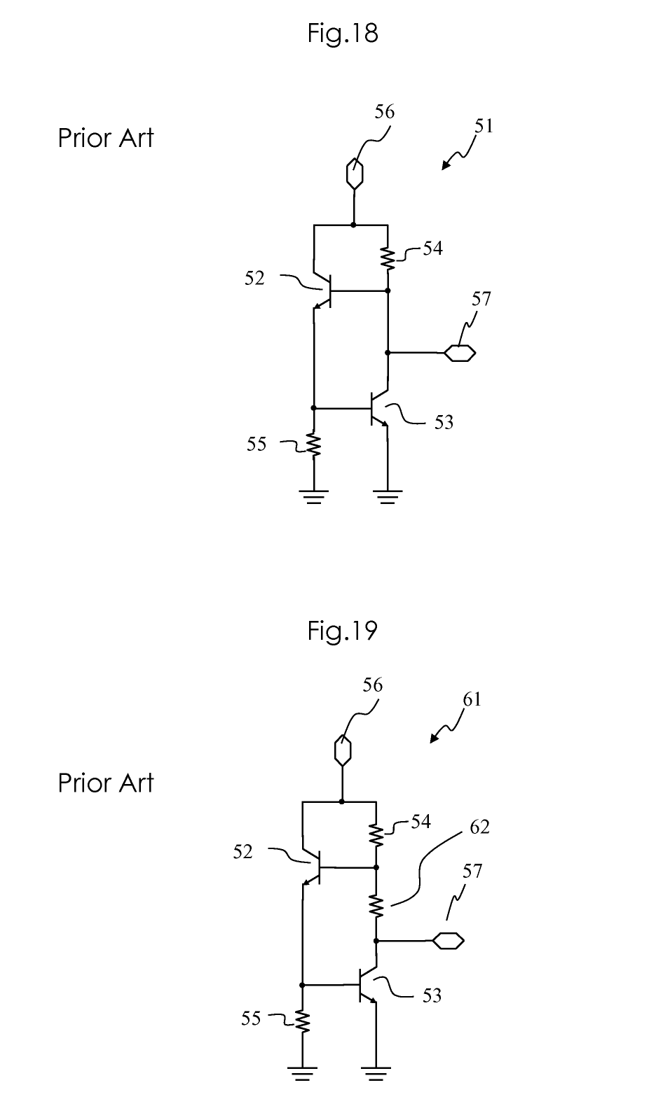

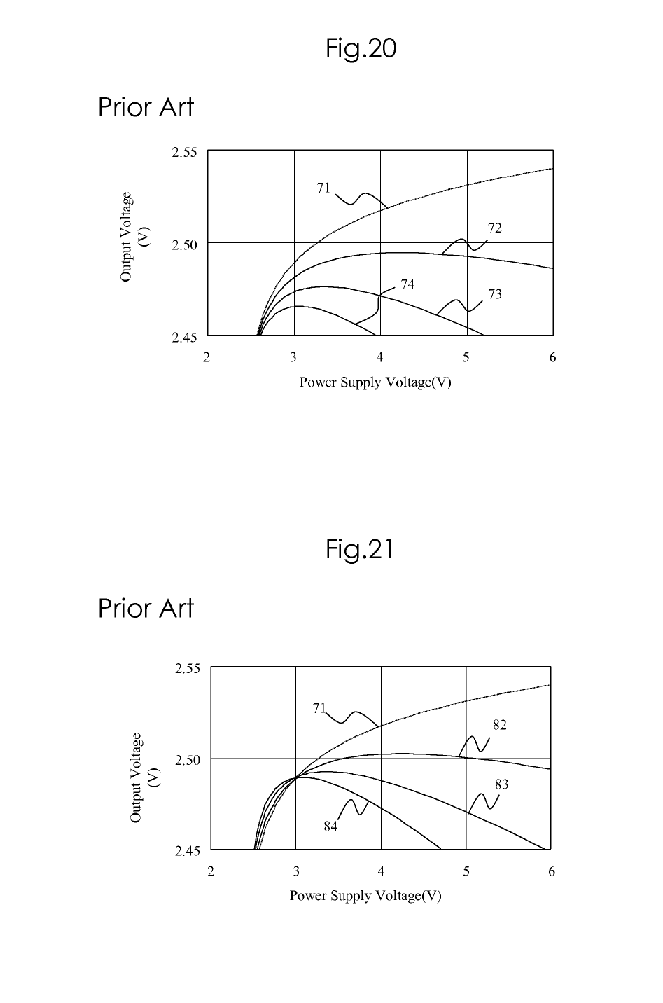

An operation of the voltage generation circuit 101 according to the present invention will be described below in comparison to the operations of the voltage generation circuits 51 and 61 in the related art. In the voltage generation circuits 51 and 61 (illustrated in FIGS. 18 and 19) in the related art, a voltage at base terminal of the transistor 52 is a summation of Vbe of the transistors 52 and 53, that is, twice Vbe. The voltage (graph curve 71) at the base terminal of the transistor 52 gradually increase by increasing the power supply voltage in a range of equal to or greater than a voltage (about 2.5 V) which causes the transistors 52 and 53 to turn ON together. However, this change of the voltage is a change from 2.4 V to 2.6 V and may be considered as being little voltage change in comparison to the change of the power supply voltage.

Accordingly, in the above-described power supply voltage range (being equal to or greater than 2.5 V), almost of a quantity of a change of the power supply voltage is a quantity of a change of a voltage at both terminals of the resistor 54, and a current in the resistor 54 is increased substantially in proportion to an “increase of the power supply voltage”. A current flowing into a base of the transistor 52 of a current flowing in the resistor 54 has a small amount and most of the current flowing in the resistor 54 flows into a collector of the transistor 53 (flows into the collector of the transistor 53 through the resistor 62 in the circuit 61), and thus a collector current of the transistor 53 increases.

In a general transistor, a base current increases rapidly with an increase of a base-emitter voltage (Vbe), like an exponential function. When a voltage necessary as a collector voltage is applied, a collector current which is β (current amplification factor) times the base current flows. That is, the collector current also increases rapidly with an increase of Vbe, like an exponential function. Conversely, considering the base current and the collector current as a reference, Vbe increases with logarithmical tardiness (changes with a slope which gradually becomes gentle) even though the current increases. This characteristic cause occurrence of properties of the output voltage of the voltage generation circuit 51 in that “a voltage generated at the voltage output terminal is gradually increased in accordance with an increase of the power supply voltage”.

The output voltage at the voltage output terminal 57 of the voltage generation circuit 61 is reduced from the output voltage of the voltage generation circuit 51 by voltage drop (current×resistance value of resistor 62) in the resistor 62. That is, the output voltage has a value of twice Vbe−(amount of the voltage drop in the resistor 62). As described above, since the current increases substantially in proportion to an increase of the power supply voltage, in a range in which the power supply voltage is equal to or greater than 2.5 V, a quantity of a change of the voltage drop in the resistor 62 is also proportional to an increase of the power supply voltage.

With the above descriptions, in the voltage generation circuit 61, a curved change (logarithmical change occurring in a base terminal voltage of the transistor 52) is negated by using a linear change (change of voltage drop of the resistor 62), and thus it is considered that a range of the power supply voltage enabling negation is limited.

Regarding the “logarithmical change of the output voltage with a gradually gentle slope for an increase of the power supply voltage”, when the power supply voltage is considered to be decreased, the slope becomes sharp. Thus, the output voltage is greatly decreased with a decrease of the power supply voltage in a low voltage range of the power supply voltage. Therefore, the slope itself is greatly changed in a region of a low power supply voltage. Accordingly, it is considered that when a flat output region is obtained by performing negation by using the linear change (change of voltage drop of the resistor 62), a range of a flat output becomes narrower as a region has a lower power supply voltage.

That is, in order to suppress the change of the output voltage in a wide power supply voltage, it is importance to suppress a logarithmical change of the output voltage due to the change of the power supply voltage, particularly, a rapid change on a low power supply voltage region. Thus, the inventors of the present invention considers that it is effective that the current flowing in the resistor 54 of the voltage generation circuit in the related art (resistor 104 of the voltage generation circuit 101 according to the present invention) is decreased at a time of applying the low power supply voltage, and thus the output voltage is increased at a time of applying the low power supply voltage, in order to suppress the rapid change on the low power supply voltage region. As a result obtained by repeating a test, a circuit configuration of the voltage generation circuit 101 according to the present invention is obtained. However, even when the current flowing in the resistor 54 of the voltage generation circuit in the related art (resistor 104 in the first embodiment) is decreased, a purpose of suppressing a quantity of a change of the current increasing with an increase of the power supply voltage so as to be small is achieved.

Similarly to the voltage generation circuits 51 and 61 in the related art, in the voltage generation circuit 101, a base voltage of the transistor 109 (graph curve 201 in FIG. 2) is changed in a range of 2.4 V to 2.6 V when the power supply voltage is equal to or greater than about 2.5 V. This change of the base voltage of the transistor 109 may seem to be substantially constant in comparison to the change of the power supply voltage. Accordingly, an increase of the current flowing in the resistor 104 is proportional to the increase of the power supply voltage. Since currents flowing in the base terminals of the transistors 103 and 108 are small, most of these currents flow into the collector terminal of the transistor 103 through the resistors 105 and 106.

A voltage at the collector terminal of the transistor 103 is lower than the voltage at the base terminal of the transistor 103 by the voltage drop in the resistors 105 and 106. However, a property of a transistor that an operation of the transistor can be performed even when the voltage at the collector terminal is slightly lower than that at the base terminal is used.

In the voltage generation circuit 101, the transistor 112 has a connection portion of an emitter terminal which is used in common with the emitter terminal of the transistor 103. Accordingly, when the collector current of the transistor 103 is small, the voltage drop in the resistors 105 and 106 may be ignored. Thus, base-emitter voltages of the transistor 112 and the transistor 103 may seem to be substantially the same. If the power supply voltage increases, the transistors 103 and 112 are operated so as to increase the collector currents. However, the transistors 103 and 112 are operated so as to decrease a base voltage of the transistor 112 due to the voltage drop of the resistors 105 and 106, in accordance with an increase of the collector current of the transistor 103. Then, after the collector current of the transistor 112 has the maximum value, it is started to decrease.

The collector current of the transistor 112 flows in the vicinity of a power supply voltage causing the collector current to be started to flow in the transistor 103 by performing the above-described operation. The collector current of the transistor 112 flows into the collector terminal of the transistor 108 as an emitter current as it is. At this time, the current on the transistor 103 side, which flows into the same terminal is relatively small, and a current flowing in the resistor 104 is decreased. That is, an action that the current flowing in the resistor 104 is decreased at a “timing when the collector current is started to flow in the transistor 103” occurs.

Regarding this action, as a result obtained by examining a simulation result, it is found that an emitter current of the transistor 112 flows into the collector terminal of the transistor 108 and thus the current of the resistor 104 is decreased. It is found that an amount obtained by decreasing the current of the transistor 103 is smaller than an amount obtained by increasing the emitter current of the transistor 112. In addition, it is found that most of an increase of the emitter current of the transistor 112 corresponds to an increase of the collector current of the transistor 108. A decrease of the emitter current of the transistor 112 and the current of the transistor 103 will be described using a graph in a second embodiment which will be described later.

That is, if the current flowing in the resistor 104 is decreased, a voltage at the base terminal of the transistor 109 increases, the emitter current of the transistor 109 increases, and the current flowing at the base terminal of the transistor 108 increases. Thus, the base voltage of the transistor 108 increases, and the collector current of the transistor 108 increases. As a result, feedback is performed in a direction in which decreasing of a current (current flowing in the resistor 104) on the transistor 103 side is suppressed.

The voltage generation circuit 101 further includes resistors 107 and 115, and a transistor 114. The base-emitter voltage of each of the transistors is set as Vbe and is calculated from an expression of “potential at the emitter terminal of the transistor 108”=“potential of the ground terminal”=0 V, in an order.

First, if the base-emitter voltage of the transistor 108 of which an emitter is grounded is focused, a “potential at the base terminal of the transistor 108”=“potential at the emitter terminal of the transistor 109”=Vbe.

If the base-emitter voltage of the transistor 109 is focused, the “potential at the base terminal of the transistor 109”=“potential at the base terminal of the transistor 103”=twice Vbe.

If the base-emitter voltage of the transistor 103 is focused, a “potential at the emitter terminal of the transistor 103”=“twice Vbe−Vbe”=Vbe.

The resistor 115 is a resistor for adjustment, and thus is ignored. An emitter terminal of the transistor 114 is considered to be grounded. If a base-emitter voltage of the transistor 114 is focused, Vbe which is a “potential at the emitter terminal of the transistor 103” is applied to the base terminal of the transistor 114 for a period of time when a current flowing in the resistor 107 is small (period of time when voltage drop in the resistor 107 may be ignored).

Accordingly, a collector current of the transistor 114, the same as in the other transistors, is started to flow in accordance with an increase of the power supply voltage. If a current flowing into the collector terminal of the transistor 108 from the emitter terminal of the transistor 103 through the resistor 107 increases, an action of the voltage drop in the resistor 107 works in a direction in which a voltage at the base terminal of the transistor 114 is decreased. That is, the collector current of the transistor 114 increases in accordance with the increase of the power supply voltage, and then has the maximum value. Then, it is started to decrease.

As described above, the collector current of the transistor 114 flows in the vicinity of the power supply voltage which causes the collector current (or emitter current) of the transistor 103 is started to flow. That is, the transistor 114 causes a current flowing into the base terminal of the transistor 108 to flow into the ground for a period of time when the collector current (or emitter current) of the transistor 103 is started to flow, and the transistor 114 suppresses an increase of the voltage at the base terminal of the transistor 108. As a result, an action that an increase of the collector current of the transistor 108 is suppressed and the current flowing in the resistor 104 is decreased at the “timing when the collector current of the transistor 103 is started to flow” occurs.

A decrease of the emitter current of the transistor 114 and the current of the transistor 103 will be described using a graph in a third embodiment which will be described later.

If the collector current of the transistor 114 flows excessively, and thus the voltage at the base terminal of the transistor 108 is excessively decreased, there is a case where the output voltage excessively increases at a time of the low power supply voltage. In this embodiment, adjustment is performed by the resistor 115 in a direction in which the collector current of the transistor 114 is decreased. The collector current of the transistor 114 may be adjusted by changing an element size of the transistor 114 in addition to a configuration by connection of the resistor 115 to the emitter terminal. In addition, a configuration in which the resistor 115 is replaced and the base terminal of the transistor 114 is connected to the collector terminal of the transistor 108 through a resistor may be used. In this manner, the resistor which connects the base terminal of the transistor 114 and the collector terminal of the transistor 108 may obtain the same characteristics as the resistor 115 by causing the resistor to have a value which is “β(current amplification factor of transistor 114)+1” times the resistor 115. Further, a result obtained by combining the above-described configurations may be used.

In the above descriptions, in the voltage generation circuit 101, in order to realize an “action of decreasing the current flowing in the resistor 104”, the transistor 112 and the transistor 114 which causes the current flowing into the base terminal of the transistor 108 to flow to the ground are provided as another path in which the current flows into the collector terminal of the transistor 108. In the voltage generation circuit 101, a function of voltage drop in the resistors 105, 106, and 107 is used such that the “action of decreasing the current flowing in the resistor 104” works at the “timing when the collector current of the transistor 103 is started to flow”, that is, “at a time of the low power supply voltage”.

In the voltage generation circuit 101, values of the resistors 104 and 111 are set to resistance values which are equal to the values of the corresponding resistors 54 and 55 in the voltage generation circuit 51 of the related art, and the transistors 108 and 109 are also set to have a size which is equal to the corresponding transistors 53 and 52. Accordingly, if the transistors 112 and 114 causing a current to flow at a time of the low power supply voltage are not provided in the voltage generation circuit 101, the output voltage at the terminal 116 is substantially the same as the output voltage of the voltage generation circuit 51 in the related art. This is clarified from that the graph curve 201 illustrated in FIG. 2 has a shape substantially close to the graph curve 71, in a range of equal to or greater than about 4 V (power supply voltage causing a function of the transistors 112 and 114 to be weakened).

Conversely, in FIG. 2, a large difference between the graph curve 201 and the graph curve 71 in a range of the power supply voltage which is equal to or less than about 4 V means that an effect of increasing the output voltage on the low power supply voltage region by the action that the current flowing in the resistor 104 is decreased at the timing when the collector current of the transistor 103 is started to flow is shown. From this, regarding the output voltage (graph curve 201) at the terminal 116 of the voltage generation circuit 101, a result of suppressing an logarithmical change of the output voltage in the graph curve 71, that is, a change of rapidly decreasing the output voltage by increasing the slope as the power supply voltage is decreased is obtained.

In the voltage generation circuit 101, the power supply voltage dependency of the output voltage at the terminal 116 is close to linearity in a range of the power supply voltage which is equal to or greater than about 2.7 V, by the above-described effect. If the power supply voltage dependency of the output voltage at the terminal 116 is close to linearity, the power supply voltage dependency may be effectively negated in a wide power supply voltage range by applying the configuration (action of the resistor 62) of the voltage generation circuit 61 in the related art. In the voltage generation circuit 101, the resistor 105 has the same function as the resistor 62 of the voltage generation circuit 61. Voltage drop occurs in proportion to a current, and thus a voltage change obtained by linearly increasing the voltage at the terminal 116 is negated. In the voltage generation circuit 101, the output voltage from the terminal 117 connected to a portion between the resistor 105 and the resistor 106 may have the above-described action by the voltage drop in the resistor 105. In practice, as illustrated in the graph curve 202 of FIG. 2, in the voltage generation circuit 101, a substantially constant output voltage is generated at the terminal 117 in the range of the power supply voltage which is equal to or greater than 2.7 V.

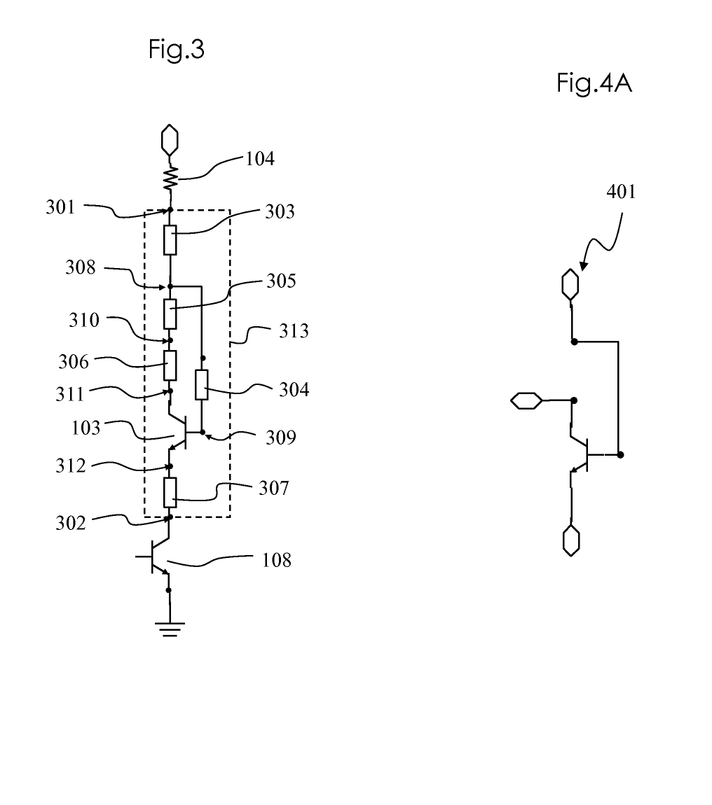

An example of a configuration usable as the first circuit will be described with reference to the drawings. FIG. 3 is a diagram illustrating the first circuit. FIG. 3 illustrates the first circuit 313 indicated by a dashed line along with the resistor 104 and the transistor 108 which are peripheral elements. A terminal 301 illustrated in FIG. 3 is a terminal (first terminal of the first circuit) to which the first resistor 104 is connected. A terminal 302 is a terminal (second terminal of the first circuit) to which the collector terminal of the first bipolar transistor 108 is connected.

The first circuit 313 is configured by the transistor 103 and the surrounding connections (303 to 307). In the first circuit 313, a path from the base terminal of the transistor 103 to the collector terminal of the transistor 103 through connections 304, 305, and 306 is a first connection path. The terminal 301 which is the first terminal, and a terminal 308 on the first connection path, which is connected by the connection 303 is the first connection terminal.

at least one of the connections (303 to 307) is a resistor and the others are wirings. For example, regarding the first circuit 118 of the voltage generation circuit 101, the connections 303 and 304 are set to be wirings and the connections 305, 306, and 307 are respectively set to be the resistors 105, 106, and 107, in a first circuit 313 of FIG. 3. In the first circuit 118, a base terminal of the transistor 112 (fourth bipolar transistor) is connected to a terminal 311 on the first connection path. An emitter terminal of the transistor 112 (fourth bipolar transistor) is connected to a path from the emitter terminal of the transistor 103 to the collector terminal of the transistor 108 through the connection 307 (to the collector terminal of the transistor 108 through the resistor 107 in the voltage generation circuit 101).

The first circuit 313 illustrated in FIG. 3 is a circuit in which a voltage for controlling the base terminal of the transistor 114 (second bipolar transistor) in the voltage generation circuit 101 is generated at the terminal 302 (collector terminal of the transistor 108 in the voltage generation circuit 101). Therefore, a circuit in which summation of the base-emitter junction voltage of the transistor 103 in a forward direction and voltage drop due to the resistor is generated in accordance with the emitter current is required between the first terminal 301 and the second terminal 302. Thus, at least one resistor is required on a path from the first terminal 301 to the second terminal 302 through the connection 303, the connection 304, base-emitter junction of the transistor 103, and the connection 307.

For example, if the connection 307 is a resistor, the emitter current of the transistor 103 directly flows in the resistor, and voltage drop occurs in accordance with the emitter current. Since substantially the same current as that in the connection 307 flows in the connection 303, if the connection 303 is a resistor, similar voltage drop occurs. Since a current which is 1/(β+1) of the emitter current flows in the base terminal of the transistor 103, if the connection 304 connected to the base terminal is a resistor, voltage drop occurs in accordance with the emitter current. When a resistor is connected at a position of the connection 304, in order to cause an action of the same voltage drop as in a case where the connections 303 and 307 are set to be resistors to occur, the resistor at the position of the connection 304 may be set to have a resistance value of (β+1) times the resistors connected at positions of the connections 303 and 307.

With the above-described configuration, it is possible to control the voltage at the base terminal of the transistor 114 as described above. That is, a voltage of Vbe is generated at the base terminal of the transistor 114, and a voltage controlled so as to cause the voltage to be decreased due to an influence of voltage drop in the resistor as the emitter current of the transistor 103 increase (as the power supply voltage increases) can be generated.

In the voltage generation circuit 101, the voltage between a base and an emitter of the transistor 112 is necessarily controlled so as to be lower than the voltage between a base and an emitter of the transistor 103 in accordance with the collector current of the transistor 103. That is, connection to a terminal at which a potential at at least the base terminal of the transistor 112 is lower than a potential at the first connection terminal 308 to which the base terminal of the transistor 103 is connected in accordance with the collector current of the transistor 103 is required. For example, if the base terminal of the transistor 112 is connected to the terminal 311 as a terminal on the first connection path between the first connection terminal 308 and the collector terminal 311 of the transistor 103, it is necessary that at least a resistor is provided at a certain position of the first connection path (connections 305 and 306) between the first connection terminal 308 and the terminal 311. (In the voltage generation circuit 101, both of the connections 305 and 306 are set to be resistors.)

The current which is 1/β of the collector current of the transistor 103 flows as the base current of the transistor 103 in the connection 304. Accordingly, when the connection 304 is a resistor, the potential at the base terminal of the transistor 103 is an amount of voltage drop in the resistor disposed at the position of the connection 304, lower than a potential at the first connection terminal 308.

At this time, adjusting of the resistor so as to cause a potential at a terminal (here, terminal 311) on the first path, to which the base terminal of the transistor 112 is connected to be additionally decreased by voltage drop in the resistor is required. That is, it is necessary that a resistor on the first connection path (paths 305 and 306) between the base terminal of the transistor 103 and the first connection terminal is set to be greater than the resistor of the connection 304 by extra 1/β of the resistor of the connection 304.

Substantially the same current as the collector current of the transistor 103 flows as the emitter current of the transistor 103 in the connection 307. Accordingly, when a resistor is provided at a position of the connection 307, and the emitter terminal of the transistor 112 is connected to the terminal 302, the potential at the terminal 302 is an amount of voltage drop lower than a potential at the emitter terminal 312 of the transistor 103. At this time, adjusting of the resistor so as to cause a potential at a terminal (here, terminal 311) on the first path, to which the base terminal of the transistor 112 is connected to be additionally decreased by voltage drop in the resistor is required. That is, it is necessary that a resistor on the first connection path (connections 305 and 306) between the base terminal of the transistor 103 and the first connection terminal is set to have a value which is greater than the resistor disposed at the position of the connection 307 by the resistor.

If the above descriptions are summarized, a condition in that the “resistor between the base terminal of the transistor 103 and the first connection terminal” is set to be greater than a summation of the “resistor of the connection 307” and “1/β of the resistor of the connection 304” is required.

With this configuration, the voltage between the base and the emitter of the transistor 112 which is the fourth bipolar transistor, due to the collector current of the transistor 103 is set to be lower than the voltage between a base and an emitter of the transistor 103 which is the third bipolar transistor by voltage drop in the resistor. Since the voltage drop increases along with an increase of the collector current, as described above, the collector current of the transistor 112 flows at a low power supply voltage, but the collector current of the transistor 112 increases to the maximum value with the increase of the power supply voltage. Then, the collector current of the transistor 112 turns to decreasing.

The base terminal or the emitter terminal of the transistor 112 may be connected to the first connection path or a “path from the emitter terminal of the transistor 103 corresponding to the connection 307 to the collector terminal of the transistor 108” through resistors. Adjustment may be performed in a direction in which the maximum value of the collector current of the transistor 112 is decreased, or the timing of the power supply voltage having the maximum value may be adjusted by using a function of the resistors. In addition, an amount of a current may be also adjusted by using an element size of the transistor 112. A result obtained by combining these configurations may be used.

A case where the collector terminal of the transistor 112 is connected to a power source through the resistor 104, that is, a case of being connected to the terminal 301, 310, or 311 in FIG. 3 is considered. When the emitter current of the transistor 112 flows on this assumption and thus the output voltage on the low power supply voltage region is increased, the collector current of the transistor 112 flows in the resistor 104, and thus voltage drop in the resistor 104 negates the effects. Accordingly, it is necessary that the collector terminal of the transistor 112 does not pass through at least a portion of the resistor 104 and thus the entirety of the effect is not negated. As in the voltage generation circuit 101, a configuration in which a portion of the resistor 104 is not present on the connection path between the collector terminal of the transistor 112 and the power supply terminal is preferable.

Next, a configuration including a voltage output terminal will be described with reference to FIG. 3. In the first circuit 313 of FIG. 3, a terminal corresponding to the terminal 116 of the voltage generation circuit 101 is the terminal 301. As described above, in the voltage generation circuit 101, regarding the output voltage generated at the terminal 116, a rapid voltage decrease on the low power supply voltage region is improved by using the function of the transistor 112 or the transistor 114 causing the current to flow.

As in the terminal 117 of the voltage generation circuit 101, when a voltage obtained by decreasing a voltage from the above improved voltage (output voltage at the terminal 116) substantially in proportion to the increase of the power supply voltage is used as an output voltage, the voltage output terminal may be disposed on the collector terminal side of the transistor 103 through a resistor when viewed from the terminal 301. That is, a resistor is disposed at a position of any one of the connections 303, 305, and 306, and the voltage output terminal is disposed with at least one resistor (for example, resistor at the position of the connection 303) interposed therebetween when viewed from the terminal 301. Thus, such an effect may be obtained.

Since the current of 1/β also flows in the connection 304 as described above, when the connection 304 is a resistor, it is possible to obtain an effect of decreasing the output voltage in accordance with the increase of the power supply voltage even when the terminal 309 on the base side of the transistor 103 with the connection 304 interposed therebetween is used as the voltage output terminal. However, when the base current is small and the connection 304 is a resistor, a large resistor may be used generally in many cases. In this case, there are many cases where an internal resistor as the power source of the voltage generation circuit is large, that is, not-preferable cases. The resistor 104 may be divided and a terminal between divided resistors may be used as the voltage output terminal. The output voltage which increases linearly for voltage which is generated at the terminal 301 and is improved on the low power supply voltage region, in accordance with the increase of the power supply voltage is obtained.

That is, if a voltage having an improved tendency that “the slope increase and the output voltage is decreased as the power supply voltage is decreased” may be generated at the terminal 301 of the first circuit 313, outputting is performed through the resistor in which the collector current of the transistor 103 flows. Thus, it is possible to obtain the output voltage having a desired slope by the resistance value of the resistor. A connection position of the base terminal of the transistor 112 to the first connection path and a connection position of the voltage output terminal have no particularly necessary condition as a mutual relationship and may be selected independently.

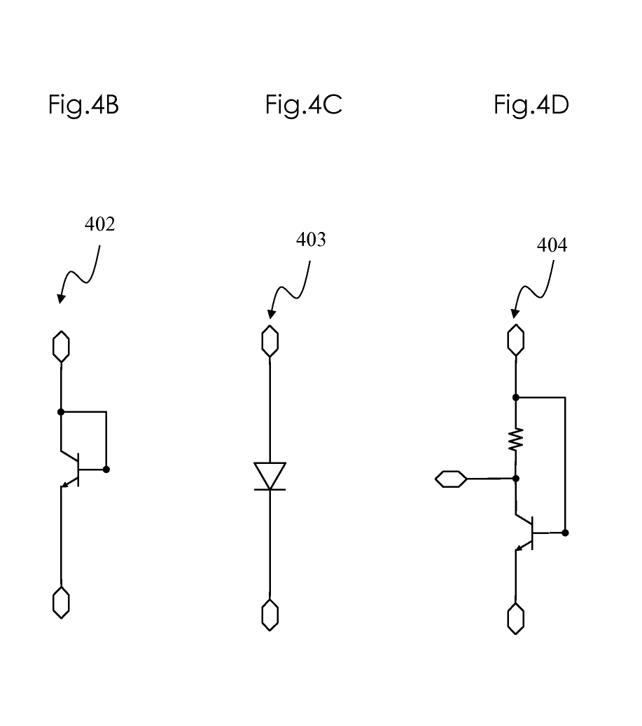

A configuration usable as the second circuit will be described with reference to the drawings. FIGS. 4A to 4D are diagrams illustrating other examples of the second circuit. In the voltage generation circuit 101, the second circuit has a purpose of generating a junction voltage between the first terminal of the first circuit and the base terminal of the first bipolar transistor 108 in the forward direction. The same configuration as that applied to the voltage generation circuit (for example, voltage generation circuits 51 and 61) in the related art may be used.

A circuit 401 in FIG. 4A is a schematic diagram of a configuration obtained by the transistors described in the configuration of the voltage generation circuit 101. A collector terminal is connected to the power source. However, as described above, a voltage may be equal to or greater than substantially a voltage of the base terminal. From this, as illustrated in a circuit 402 of FIG. 4B, a configuration of connecting the collector terminal to a base terminal may be made. If the circuit 402 is recognized as a 2-terminal circuit, diode characteristics are obtained. Thus, as in a circuit 403 of FIG. 4C, replacement with a diode may be performed. At this time, the diode may be used as a circuit in which one terminal of a transistor is not connected in addition to a circuit of using of two terminals of the transistor as in the circuit 402. In a case of the diode, the diode is required to be connected so as to have an orientation of the forward direction for the power source 102. As in a circuit 404 of FIG. 4D, even when a collector terminal and a base terminal are connected to each other through a resistor, the base terminal is set as the first terminal, and the emitter terminal is set as the second terminal, if an amount of voltage drop in the resistor is in a voltage allowable range of the collector terminal, an operation similar to the diode is performed. In this case, the voltage at the collector terminal may be used as another control voltage.

Generally, if a resistor is connected in series to a diode which is a second junction element, or if a resistor is inserted between the base terminal of a transistor and the circuit or between the emitter terminal thereof and the circuit, a current flowing in the resistor increases with the increase of the power supply voltage, and thus the output voltage increases in many cases. Accordingly, there are many cases which are not preferable for the purpose of the present invention that “the output voltage gradually increasing with the increase of the power supply voltage is improved”. However, as will be described later, when the current flowing in the resistor decreases with the increase of the power supply voltage, there is a case where a resistor is inserted, and thus the output voltage gradually increasing with the increase of the power supply voltage can be improved. There is also a case where insertion of a resistor may be used as one of adjustment methods of the power supply voltage dependency of the output voltage.

A resistor 111 disposed in the voltage generation circuit 101 is not used as a necessary component (in a circuit which will be described later, an example of no resistor 111 is illustrated). However, the presence of the resistor 111 causes an effect that a current rapidly flows in the transistor 109 and thus a voltage between a base and an emitter of the transistor 109 becomes rapidly stable to be obtained. When the power supply voltage is low, there is an effect that an extra increase of the base voltage of the transistor 108 is suppressed, the collector current of the transistor 108 (current flowing in the resistor 104) is suppressed, and the output voltage increase by decreasing the voltage drop in the resistor 104. Thus, an effect of a relatively good operation in the low power supply voltage is also obtained. A configuration in which a diode, a series circuit of a diode and a resistor, and a current source such as a current mirror may be connected instead of the resistor 111, and thus a current from an emitter of the transistor 109 flows to the ground may be made.

It is possible to provide a voltage generation circuit in which the power supply voltage dependency in the low voltage is improved, by using the voltage generation circuit 101 according to the present invention and to provide a voltage generation circuit having a low power supply voltage dependency in a wider power supply voltage range.

### Second Embodiment

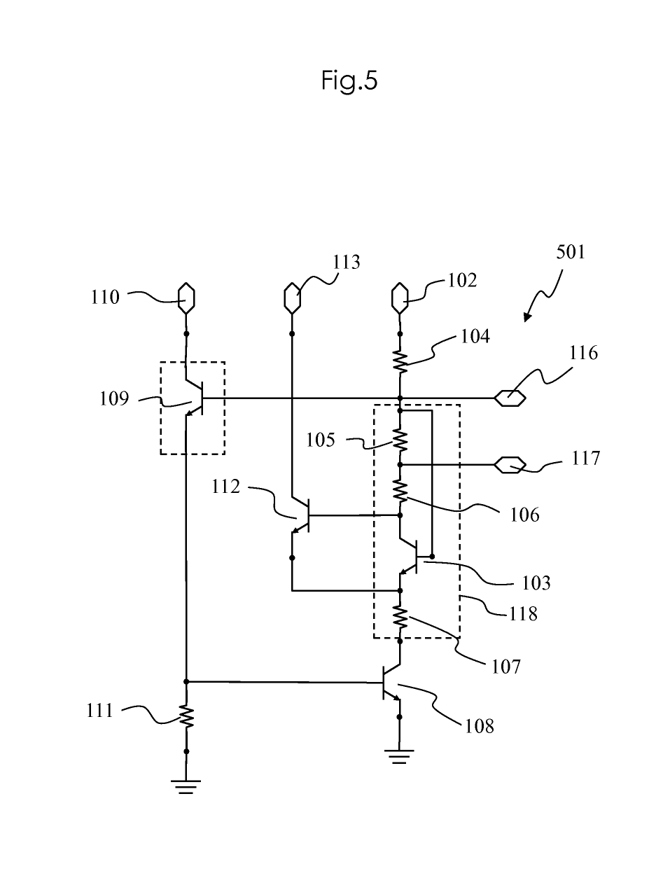

Another example of the voltage generation circuit according to the present invention will be described with reference to the drawings. FIG. 5 is a circuit diagram illustrating another example of the voltage generation circuit according to the present invention.

As illustrated in FIG. 5, a voltage generation circuit 501 has the same configuration as the voltage generation circuit 101 illustrated in FIG. 1 except that the transistor 114 which is the second bipolar transistor and the resistor 115 are not included. This embodiment is used for describing obtaining of an effect that an effect of the function of the resistors 105 and 106 and the transistor 112 causing the action that the current flowing in the resistor 104 is decreased at the timing when the collector current of the transistor 103 is started to flow and of increasing the output voltage on the low power supply voltage region is also shown, in the configuration in which the transistor 114 and the resistor 115 are not included.

In the following descriptions, in order to demonstrate an operation of the voltage generation circuit 501, simulation is performed by using a model of the circuit configuration in FIG. 5, and thus a value of the output voltage and the like is calculated.

In the simulation, the fourth transistor 112 is set to an element having a four times emitter size. The resistor 105 is set as 35Ω, and the resistor 106 is set as 165Ω. All of the power supply voltages applied to all of the power supply terminals 102, 110, and 113 are set to have the same voltage.

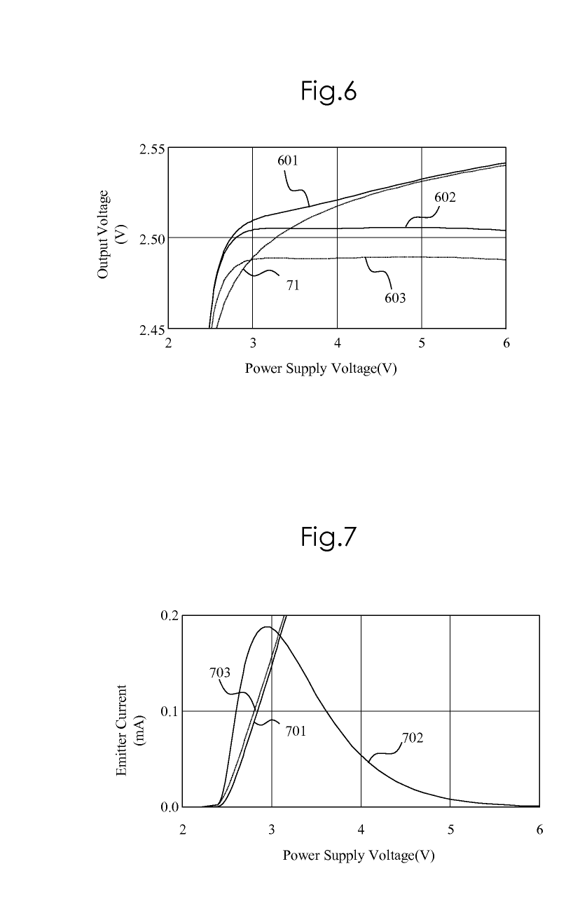

FIG. 6 is a diagram illustrating a relationship between an output voltage and a power supply voltage of the voltage generation circuit illustrated in FIG. 5. FIG. 7 is a diagram illustrating a relationship between a current of each component and a power supply voltage of the voltage generation circuit illustrated in FIG. 5.

In FIG. 6, a graph curve 601 is a graph illustrating a relationship between the output voltage and the power supply voltage when a terminal 116 of the voltage generation circuit 501 is used as the voltage output terminal. A graph curve 602 illustrates a relationship between the output voltage and the power supply voltage when a terminal 117 of the voltage generation circuit 501 is used as the voltage output terminal. A graph curve 603 illustrates a relationship between the output voltage and the power supply voltage of the voltage generation circuit 501 obtained by changing the size of the transistor 109 to a 1.9 times emitter size such that the output voltage at the terminal 117 when the power supply voltage is 3 V is the same as the output voltage of the voltage generation circuit 51 in the related art. As a graph curve 71 for comparison, a graph indicating a relationship between the output voltage and the power supply voltage of the voltage output circuit 51 in the related art is illustrated.

As illustrated in the graph curve 601 of FIG. 6, an output voltage at the low power supply voltage when the terminal 116 of the voltage generation circuit 501 is used as the voltage output terminal is higher than the output voltage (graph curve 71) of the voltage generation circuit 51 in the related art. Thus, characteristics that the slope becomes greater as the power supply voltage is decreased, and thus the output voltage is reduced are improved, and the slope when the power supply voltage is higher than about 3 V becomes substantially a straight line.

As illustrated in the graph curve 602, an output voltage when the terminal 117 of the voltage generation circuit 501 is used as the voltage output terminal becomes substantially constant at the power supply voltage of equal to or greater than about 3 V.

As illustrated in the graph curve 603, it is possible to confirm that the power supply voltage dependency in the voltage generation circuit 501 (model for comparing the power supply voltage dependency of the output voltage with more accuracy) obtained by changing the size of the transistor 109 is smaller than the power supply voltage dependency of the output voltage of the voltage generation circuit 51 in the related art, in a wide range.

An operation of the voltage generation circuit 501 according to the present invention will be described below. The voltage generation circuit 501 has a configuration obtained by excluding the transistor 114 and the resistor 115 from the voltage generation circuit 101. The voltage generation circuit 501 is used for describing obtaining of an effect that an effect of the function of the resistors 105 and 106 and the transistor 112 causing the action that the current flowing in the resistor 104 is decreased at the timing when the collector current of the transistor 103 is started to flow and of increasing the output voltage on the low power supply voltage region is also shown in the configuration in which the transistor 114 and the resistor 115 are not included. The voltage generation circuit 501 is described as an example of the transistor 112 having a large element size in order to enhance the function of the transistor 112 because the function of the transistor 114 is not used.

In FIG. 7, a graph curve 701 illustrates a relationship between the emitter current of the transistor 103 and the power supply voltage in the voltage generation circuit 501. A graph curve 702 illustrates a relationship between the emitter current of the transistor 112 and the power supply voltage. As a graph curve 703 for comparison, a graph indicating a relationship between the emitter current of the third transistor 103 and the power supply voltage in a circuit obtained by removing the fourth transistor 112 from the power source generation circuit 501 is illustrated.

As illustrated in the graph curve 702 of FIG. 7, it is found that the emitter current of the transistor 112 mainly flows on the low power supply voltage region. The graph curve 702 is slightly lower than the graph curve 703. It is found that the presence of the transistor 112 causing the current to flow on the low power supply voltage region causes the emitter current of the transistor 103 to be relatively decreases from the graph curve 703 to the graph curve 701.

As in the above-described voltage generation circuit 101, an amount of a decrease (difference between the graph curve 703 and the graph curve 701) of the emitter current of the transistor 103 is smaller than the emitter current (graph curve 702) of the transistor 112. Most of the current of the transistor 112 causes an increase of the collector current of the transistor 108. Thus, the emitter current (current flowing in the resistor 104) of the transistor 103 is slightly decreased, and an effect of increasing the output voltage on the low power supply voltage region is shown by the action.

From this, it is also possible to cause the power supply voltage dependency of the output voltage to have a shape close to a straight line in the voltage generation circuit 501 by increasing the output voltage on the low power supply voltage region. If the power supply voltage dependency of the output voltage has the shape close to the straight line, voltage drop in proportion to the current occurs in the resistor 105. Thus, the voltage at the terminal 116 at which the voltage increases linearly may be negated and an output voltage having small voltage power supply voltage dependency in a wide power supply voltage range may be generated at the terminal 117.

A configuration usable as a first circuit of the voltage generation circuit 501 will be described below using the first circuit 313 in FIG. 3. The voltage generation circuit 501 has a configuration in which the transistor 114 and the resistor 115 of the voltage generation circuit 101 are not included, and has no necessity for controlling the base voltage of the transistor 114. Thus, it is not necessary that the first circuit 313 generates the base-emitter junction voltage of the transistor 103 in the forward direction and voltage drop due to the resistor between the first terminal 301 and the second terminal 302 in accordance with the emitter current. Accordingly, a resistor is not required on a path from the first terminal 313 to the second terminal through the connection 303, the connection 304, the base-emitter junction of the transistor 103, and the connection 307. That is, the resistor 107 illustrated in the voltage generation circuit 501 is not a particularly necessary component in this embodiment. Since there is no influence on an operation even though a resistor is provided, the resistor 107 remains in the voltage generation circuit 501.

In order to control the base-emitter voltage of the transistor 112, a condition necessary for a first connection terminal on a connection point of the first connection path and a connection point of the base terminal of the transistor 112, and a resistance value on the first connection path between the first connection terminal and the connection point of the base terminal of the transistor 112 is the same as in the voltage generation circuit 101. A configuration by elements except for the transistor 114 and the resistor 115 or a method of adjustment is similar to that in the voltage generation circuit 101.

### Third Embodiment

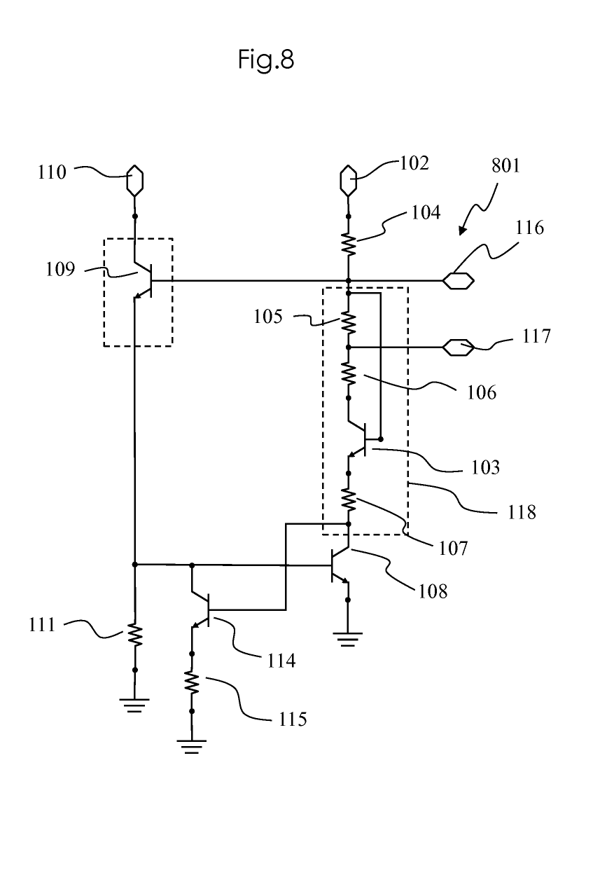

Yet another example of the voltage generation circuit according to the present invention will be described with reference to the drawings. FIG. 8 is a circuit diagram illustrating yet another example of the voltage generation circuit according to the present invention.

As illustrated in FIG. 8, a voltage generation circuit 801 has the same configuration as the voltage generation circuit 101 except that the transistor 112 which is the fourth bipolar transistor and the power supply terminal 113 are not included. This embodiment is used for describing obtaining of an effect that an effect of the function of the resistors 107 and 115 and the transistor 114 causing the action that the current flowing in the resistor 104 is decreased at the timing when the collector current of the transistor 103 is started to flow and of increasing the output voltage on the low power supply voltage region is also shown, in the configuration in which the transistor 112 and the power supply terminal 113 are not included.

In the following descriptions, in order to demonstrate an operation of the voltage generation circuit 801, simulation is performed by using a model of the circuit configuration in FIG. 8, and thus a value of the output voltage and the like is calculated.

In the simulation, in order to enhance the function of the transistor 114 which is the second bipolar transistor because the function of the fourth transistor 112 in the voltage generation circuit 101 is not used, the resistance value of the resistor 107 which is 200Ω in the voltage generation circuit 101 is set to 50Ω in the power source generation circuit 801. The power supply voltages applied to the power supply terminals 102 and 110 are set to have the same voltage.

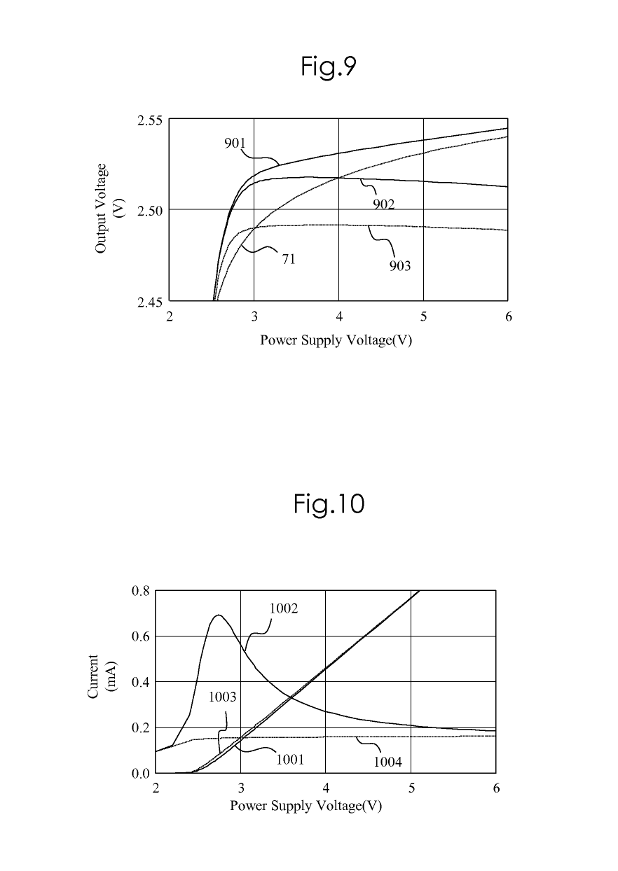

FIG. 9 is a diagram illustrating a relationship between an output voltage and a power supply voltage in the voltage generation circuit illustrated in FIG. 8. FIG. 10 is a diagram illustrating a relationship between a current of each component and the power supply voltage in the voltage generation circuit illustrated in FIG. 8.

In FIG. 9, a graph curve 901 is a graph illustrating a relationship between the output voltage and the power supply voltage when a terminal 116 of the voltage generation circuit 801 is used as the voltage output terminal. A graph curve 902 illustrates a relationship between the output voltage and the power supply voltage when a terminal 117 of the voltage generation circuit 801 is used as the voltage output terminal. A graph curve 903 illustrates a relationship between a voltage output and the power supply voltage of the voltage generation circuit 801 obtained by changing a resistance value of the resistor 111 so as to be 2400Ω such that the output voltage at the terminal 117 when the power supply voltage is 3 V is the same as the output voltage of the voltage generation circuit 51 in the related art. As a graph curve 71 for comparison, a graph indicating a relationship between the output voltage and the power supply voltage of the voltage output circuit 51 in the related art is illustrated.

As illustrated in the graph curve 901 of FIG. 9, an output voltage at the low power supply voltage when the terminal 116 of the voltage generation circuit 801 is used as the voltage output terminal is higher than the output voltage (graph curve 71) of the voltage generation circuit 51 in the related art. Thus, characteristics that the slope becomes greater as the power supply voltage is decreased, and thus the output voltage is reduced are improved, and the slope when the power supply voltage is higher than about 3 V has a shape close to a straight line.

As illustrated in the graph curve 902, an output voltage when the terminal 117 of the voltage generation circuit 801 is used as the voltage output terminal becomes substantially constant at the power supply voltage of equal to or greater than about 3 V.

As illustrated in the graph curve 903, it is possible to confirm that the power supply voltage dependency in the voltage generation circuit 801 (model for comparing the power supply voltage dependency of the output voltage with more accuracy) obtained by changing the resistance value of the resistor 111 is smaller than the power supply voltage dependency of the output voltage of the voltage generation circuit 51 in the related art, in a wide power supply voltage range.

An operation of the voltage generation circuit 801 according to the present invention will be described below. A graph curve 1001 illustrated in FIG. 10 indicates the emitter current of the transistor 103 in the voltage generation circuit 801 and a graph curve 1002 indicates a summation of a current flowing in the resistor 111 and the collector current of the transistor 112. For comparison, a graph curve 1003 indicating an emitter current of the transistor 103 when simulation for a circuit obtained by removing the transistor 114 and the resistor 115 from the voltage generation circuit 801 is performed is illustrated, and a graph curve 1004 indicating the current flowing in the resistor 111 at that time is illustrated.

As illustrated in FIG. 10, it is found that the presence of the transistor 114 causes a current (graph curve 1002) flowing into the ground by the transistor 114 and the resistor 111 to be greater than a current (graph curve 1004) of only the resistor 111 without the transistor 114, on the low power supply voltage region. The graph curve 1001 is slightly lower than the graph curve 1003. It is found that the presence of the transistor 114 causing the current to flow on the low power supply voltage region causes the emitter current of the transistor 103 to be relatively decreases from the graph curve 1003 to the graph curve 1001. Thus, the emitter current (current flowing in the resistor 104) of the transistor 103 is slightly decreased, and an effect of increasing the output voltage on the low power supply voltage region is shown by the action.

From this, it is also possible to cause the power supply voltage dependency of the output voltage to have a shape close to a straight line in the voltage generation circuit 801 by increasing the output voltage on the low power supply voltage region. If the power supply voltage dependency of the output voltage has the shape close to the straight line, voltage drop in proportion to the current occurs in the resistor 105. Thus, the voltage at the terminal 116 at which the voltage increases linearly may be negated and an output voltage having small dependency on the power supply voltage in a wide power supply voltage range may be generated at the terminal 117.

A configuration usable as the first circuit will be described using FIG. 3. As described above, the voltage generation circuit 801 has a configuration in which the transistor 112 and the power supply terminal 113 of the voltage generation circuit 101 are not included. Accordingly, a condition regarding a position for connecting the base terminal and the emitter terminal of the transistor 112 and a resistance value between connection terminals for controlling a voltage difference thereof is not required. That is, the resistor 106 illustrated in the voltage generation circuit 801 is not particularly necessary.

When the voltage output terminal 116 is used without using of the voltage output terminal 117, the resistor 105 also is not necessary and the transistor 103 has a configuration in which the base terminal and the collector terminal are connected to each other. Thus, replacement from the transistor 104 to the a diode may be performed, that is, the first circuit may be made by a series circuit of a diode connected in the forward direction, and a resistor. Since there is no influence on an operation even though a resistor is provided at a position of the resistor 106, the voltage generation circuit 801 is illustrated with a form in which the resistor 106 remains.

In order to control the voltage at the base terminal of the transistor 114, it is necessary that the first circuit 313 generates the base-emitter junction voltage of the transistor 103 in the forward direction (or diode junction voltage in the forward direction) and voltage drop due to the resistor between the first terminal 301 and the second terminal 302 in accordance with the emitter current (or diode current). Accordingly, a resistor is required at at least a certain location of a path from the first terminal to the second terminal through the connection 303, the connection 304, the base-emitter junction of the transistor 103, and the connection 307. In addition, a configuration by elements except for the transistor 112 and the power supply terminal 103 or a method of adjustment is similar to that in the circuit 101.

### Fourth Embodiment

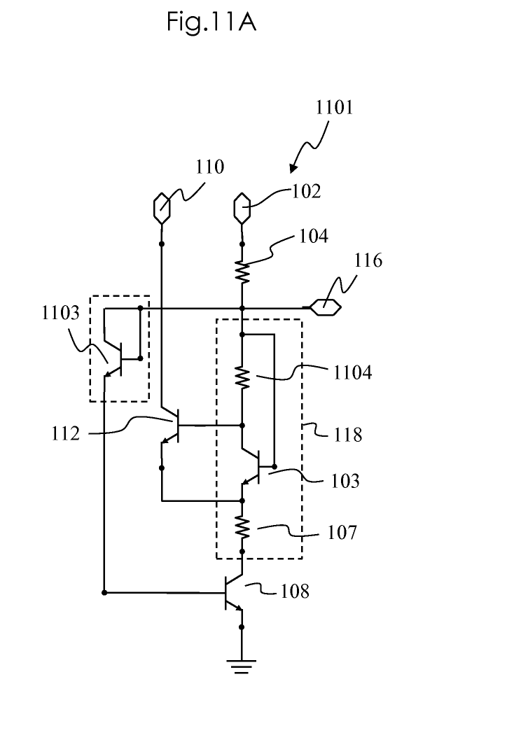

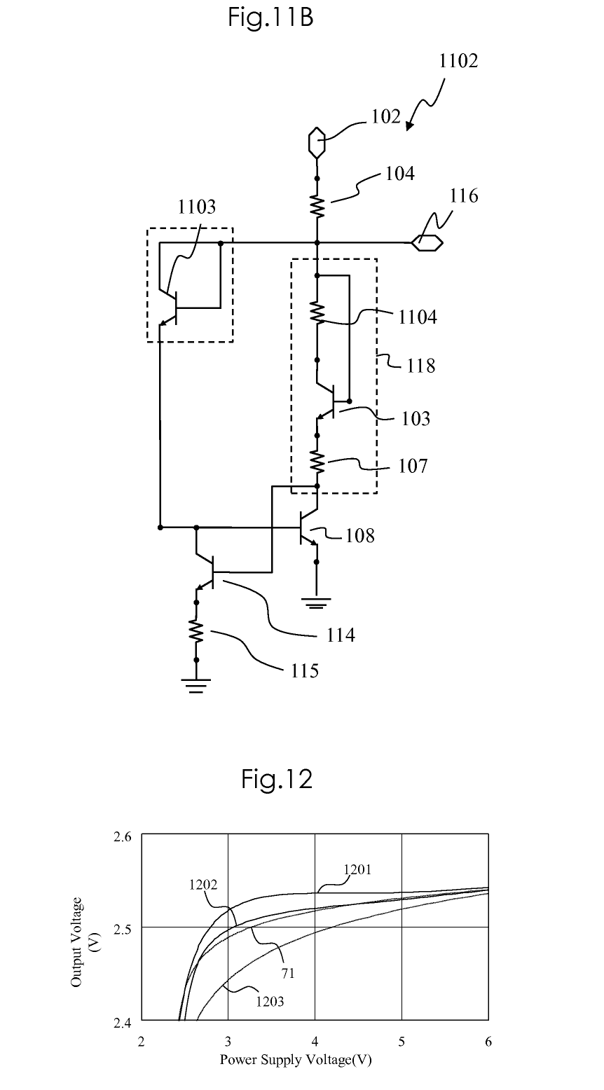

Yet another example of the voltage generation circuit according to the present invention will be described with reference to the drawings. FIG. 11A is a circuit diagram illustrating yet another example of the voltage generation circuit according to the present invention. FIG. 11B is a circuit diagram illustrating yet another example of the voltage generation circuit according to the present invention.

As illustrated in FIGS. 11A and 11B, each of a voltage generation circuit 1101 and a voltage generation circuit 1102 includes a transistor 1103 of which a base terminal and a collector terminal are connected to each other. The transistor 1103 may seem like a diode by setting the base terminal as an anode terminal and setting the emitter terminal as a cathode terminal.

Here, the diode 1103 (transistor 1103) is the second circuit, the anode terminal of the diode is the first terminal, and the cathode terminal thereof is the second terminal.

The voltage generation circuits 1101 and 1102 are used as a voltage generation circuit in which the terminal 117 is omitted and only the terminal 116 is included.

In the following descriptions, in order to demonstrate an operation of the voltage generation circuits 1101 and 1102, simulation is performed by using a model of the circuit configuration in FIGS. 11A and 11B, and thus a value of the output voltage and the like is calculated.

In the simulation, the transistor 1103 has an emitter size of 1/10. Resistors 1104 and 107 are set to 100Ω. A resistor 115 is set to 2000Ω. In the voltage generation circuit 1101, the power supply voltages applied to the power supply terminals 102 and 110 are set to have the same voltage.

FIG. 12 is a diagram illustrating a relationship between an output voltage and a power supply voltage in each of the voltage generation circuits illustrated in FIGS. 11A and 11B. In FIG. 12, a graph curve 1201 is a graph indicating a relationship between the output voltage and the power supply voltage of the voltage generation circuit 1101. A graph curve 1202 is a graph indicating a relationship between the output voltage and the power supply voltage of the voltage generation circuit 1102. As a graph curve 71 for comparison, a graph indicating a relationship between the output voltage and the power supply voltage of the voltage generation circuit 51 in the related art is illustrated.

In the circuit of this embodiment, the second circuit is configured by the diode 1103. Thus, it is difficult to perform direct comparison to the voltage generation circuit 51 in the related art. A configuration (both circuits have the same configuration) in which the transistors 112 and 114, and the resistor 115 in each of the voltage generation circuits 1101 and 1102 are not provided is set as a comparison circuit and a relationship between a voltage output thereof and the power supply voltage is indicated as a graph curve 1203.

As illustrated in the graph curve 1203 of FIG. 12, the output voltage on the low power supply voltage region in the above-described comparison circuit is lower than the output voltage of the voltage generation circuit 51 in the related art. This is obtained by replacing the transistor in the second circuit with a diode. Thus, comparison in characteristics of the output voltage (graph curve 1203) is performed below between the voltage generation circuits 1101 and 1102 (graph curves 1201 and 1202) having the same configuration of the second circuit and the comparison circuit.

As illustrated in the graph curve 1201 of FIG. 12, at the low power supply voltage region, the output voltage of the voltage generation circuit 1101 is higher than the output voltage (graph curve 1203) of the above-described comparison circuit. Thus, characteristics that the slope becomes greater as the power supply voltage is decreased, and thus the output voltage is reduced are improved, and the slope when the power supply voltage is higher than about 3.5 V becomes substantially a straight line. As illustrated in the graph curve 1202 of FIG. 12, at the low power supply voltage region, the output voltage of the voltage generation circuit 1102 is higher than the output voltage (graph curve 1203) of the above-described comparison circuit. Thus, characteristics that the slope becomes greater as the power supply voltage is decreased, and thus the output voltage is reduced are improved, and the slope when the power supply voltage is higher than about 3.5 V becomes substantially a straight line.

An operation of the voltage generation circuits 1101 and 1102 according to the present invention will be described below.

Each of the voltage generation circuit 1101 and the voltage generation circuit 1102 has a configuration in which the transistor 109 which is a junction element of the second circuit in the voltage generation circuit 501 and the voltage generation circuit 801 is replaced with the diode 1103 and the resistor 111 is omitted. With such a configuration, an action that the current flowing in the resistor 104 is decreased at the “timing when the collector current of the transistor 103 is started to flow” also occurs. This action occurs by the function of the resistor 1104 and the transistor 112 in the voltage generation circuit 1101 or by the function of the resistors 107 and 115, and the transistor 114 in the voltage generation circuit 1102. An effect in that an effect of increasing the output voltage on the low power supply voltage region is also shown is obtained by this action.

From the above descriptions, it is found that the transistor 109 of the second circuit in the voltage generation circuit 501 and the voltage generation circuit 801 may be replaced with the diode 1103 or the resistor 111 may be omitted. However, as the second circuit, the configuration (voltage generation circuits 501 and 801) by the transistor 109 originally has better power supply voltage dependency of the output voltage on the low power supply voltage region than that in the configuration by the diode 1103. Accordingly, a case where the configuration by the transistor 109 is combined with the configuration (function of the transistor 112 or 114) according to the present invention is more effective than the configuration by the diode 1103.

### Fifth Embodiment

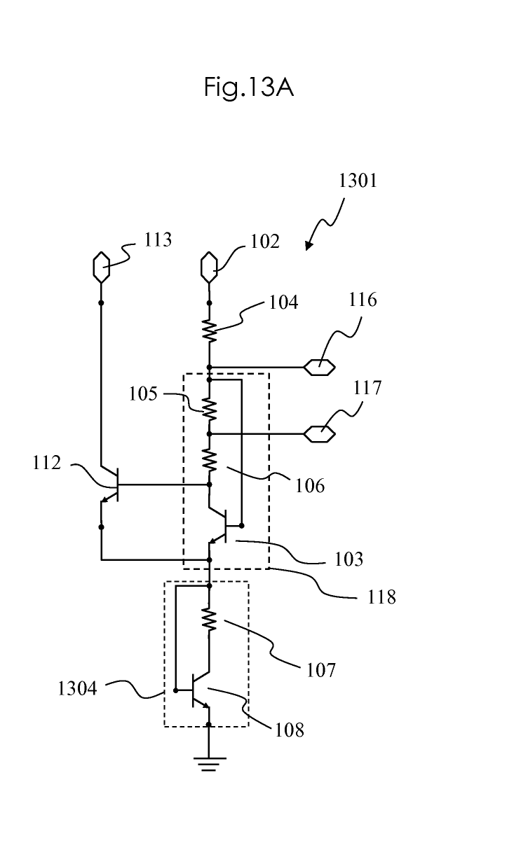

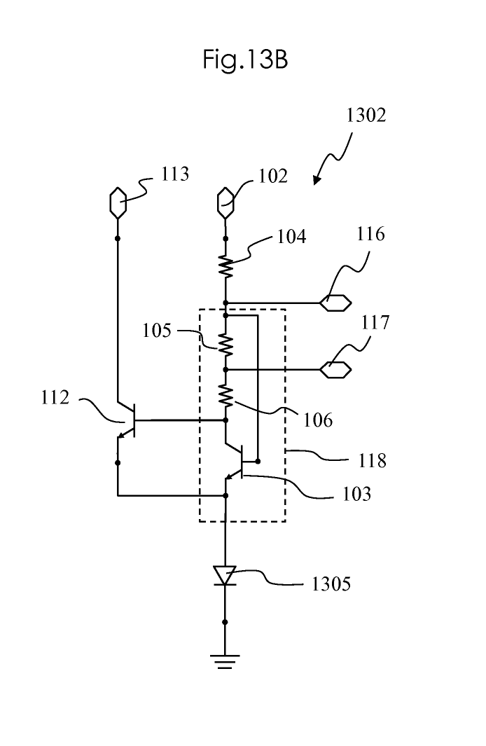

Yet another example of the voltage generation circuit according to the present invention will be described with reference to the drawings. FIG. 13A is a circuit diagram illustrating yet another example of the voltage generation circuit according to the present invention. FIG. 13B is a circuit diagram illustrating a replaceable circuit of the voltage generation circuit illustrated in FIG. 13A.

As illustrated in FIG. 13A, a voltage generation circuit 1301 has a configuration in which the diode 1103 in the above-described voltage generation circuit 1101 is omitted and the base terminal of the transistor 108 is connected to the emitter terminal of the transistor 103 (an example of using the terminal 117 as the voltage output terminal is also described). A diode 1304 is a diode in which the transistor 108 of which the base terminal and the collector terminal are connected to each other through the resistor 107. In the diode 1304, the base terminal of the transistor 108 is set as an anode terminal and the emitter terminal is set as a cathode terminal. A voltage generation circuit 1302 is a circuit in which the above diode 1304 is described as a 2-terminal diode 1305 and which is equivalent to the voltage generation circuit 1301.

Here, the diode 1304 and the diode 1305 are first diodes.

In the following descriptions, in order to demonstrate an operation of the voltage generation circuits 1301 and 1302, simulation is performed by using a model of the circuit configuration in FIGS. 13A and 13B, and thus a value of the output voltage and the like is calculated. In the simulation, the transistor 112 is set to have a 9 times element size, the resistor 105 is set to 70Ω, and the resistor 106 is set to 130Ω. The power supply voltages applied to the power supply terminals 102 and 110 are set to have the same voltage.

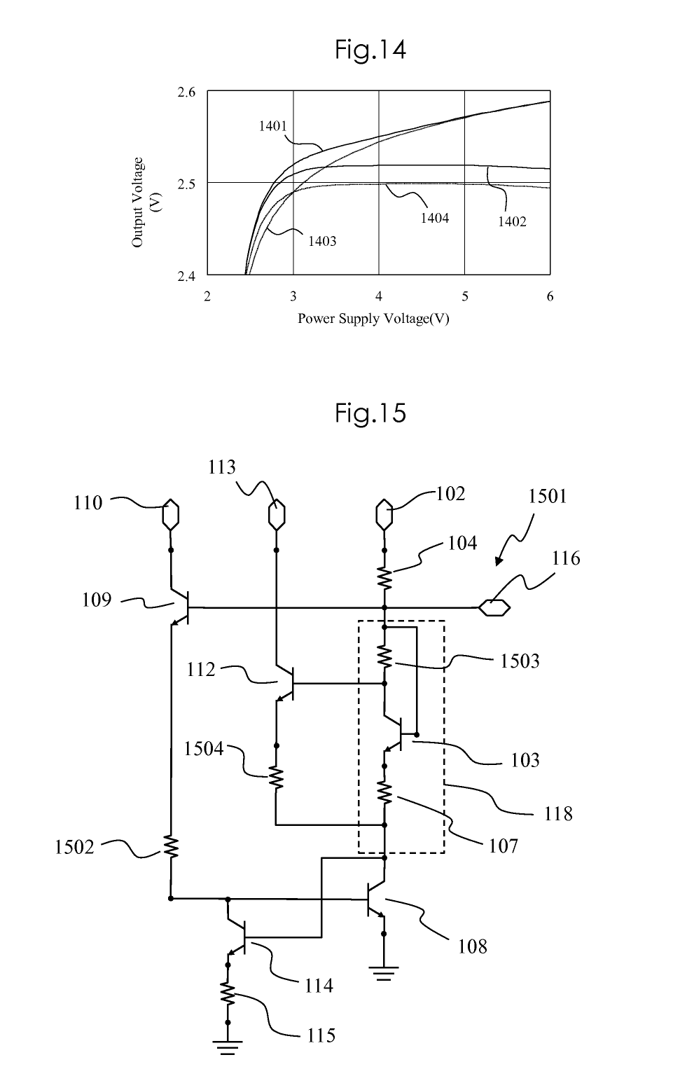

FIG. 14 is a diagram illustrating a relationship between an output voltage and a power supply voltage in the voltage generation circuit illustrated in FIGS. 13A and 13B.

In FIG. 14, a graph curve 1401 is a graph indicating a relationship between the output voltage and the power supply voltage when the terminal 116 of the voltage generation circuit 1301 is used as the voltage output terminal. A graph curve 1402 is a graph indicating a relationship between the output voltage and the power supply voltage when the terminal 117 of the voltage generation circuit 1301 is used as the voltage output terminal. In this embodiment (voltage generation circuits 1301 and 1302), the second circuit is not provided and thus it is difficult to perform direct comparison to the voltage generation circuit 51 in the related art. As a graph curve 1403 for comparison, a graph indicating a relationship between an output voltage and a power supply voltage of a comparison circuit obtained by removing the transistor 112 from the voltage generation circuit 1301 is illustrated.

A graph curve 1404 is a graph indicating a relationship between the output voltage at the terminal 117 and the power supply voltage in the voltage generation circuit 1301 obtained by changing the size of the transistor 108 so as to be 2.2 times the emitter area such that the output voltage at the terminal 117 when the power supply voltage is 3 V is the same as the output voltage of the above-described comparison circuit.

As illustrated in the graph curve 1401 of FIG. 14, the output voltage at the low power supply voltage region, when the terminal 116 of the voltage generation circuit 1301 is used as the voltage output terminal is higher than the output voltage (graph curve 1403) of the above-described comparison circuit. Thus, characteristics that the slope becomes greater as the power supply voltage is decreased, and thus the output voltage is reduced are improved, and the slope when the power supply voltage is higher than about 3 V has a shape close to a straight line.

As illustrated in the graph curve 1402, an output voltage when the terminal 117 of the voltage generation circuit 1301 is used as the voltage output terminal becomes substantially constant at the power supply voltage of equal to or greater than about 3 V.

As illustrated in the graph curve 1403, it is possible to confirm that the power supply voltage dependency in the voltage generation circuit 1301 (model for comparing the power supply voltage dependency of the output voltage with more accuracy) obtained by changing the size of the transistor 108 is smaller than the power supply voltage dependency of the output voltage of the above-described comparison circuit, in a wide power supply voltage range.

An operation of the voltage generation circuits 1301 and 1302 according to the present invention will be described below.

In the voltage generation circuit 1101 of FIG. 11A, the voltage at the terminal 116 is decreased by a junction voltage of the diode 1103 in the forward direction (junction voltage of base-emitter junction of a transistor constituting the diode 1103, in the forward direction), and is applied to the base terminal of the transistor 108.

On the contrary, it is found that if it is considered that the voltage at the terminal 116 is decreased by a junction voltage of base-emitter junction of the transistor 103 in the forward direction, and is applied to a base terminal of the transistor 1303, substantially the same operation is performed in the voltage generation circuit 1301 of FIG. 13A. That is, an effect of the function of the resistors 105 and 106 and the transistor 112 causing the action that the current flowing in the resistor 104 is decreased at the timing when the collector current of the transistor 103 is started to flow and of increasing the output voltage on the low power supply voltage region is shown. The output voltage on the low power supply voltage region is increased and the power supply voltage dependency of the output voltage has a shape closed to a straight line, and thus the voltage drop in proportion to the current occurs in the resistor 105. Accordingly, the voltage at the terminal 116 at which the voltage increases linearly may be negated and an output voltage having small voltage power supply voltage dependency in a wide power supply voltage range may be generated at the terminal 117.

In the voltage generation circuit 1301, the resistor 107 is not required for an operation, similarly to in the voltage generation circuit 1101, and may be omitted. An operation may be performed even though the resistor 107 is provided, and a configuration example of the voltage generation circuit 1301, in which the resistor is provided is described.

### Sixth Embodiment

Yet another example of the voltage generation circuit according to the present invention will be described with reference to the drawings. FIG. 15 is a circuit diagram illustrating yet another example of the voltage generation circuit according to the present invention.

As illustrated in FIG. 15, in comparison to the voltage generation circuit 101, in a voltage generation circuit 1501, a resistor 1502 is connected to a portion between the emitter terminal of the transistor 109 and the base terminal of the transistor 108 which is the first bipolar transistor, in the voltage generation circuit 101. Instead of the resistors 105 and 106 of the first circuit, a resistor 1503 is connected. The emitter terminal of the transistor 112 which is the fourth bipolar transistor is connected to the collector terminal of the transistor 108 through a resistor 1504. The resistor 111 is omitted.

In the following descriptions, in order to demonstrate an operation of the voltage generation circuit 1501, simulation is performed by using a model of the circuit configuration in FIG. 15, and thus a value of the output voltage and the like is calculated.

In the simulation, the transistors 114 and 112 are set to have 4 times an element size. The transistor 108 is set to have 1.1 times an element size. The transistor 109 is set to have 1.5 times an element size. A resistance value of the resistor 1502 is set to 10Ω, a resistance value of the resistor 1503 is set to 400Ω, and a resistance value of the resistor 115 is set to 130Ω. A resistance value of the resistor 1504 is set to 200Ω and a resistance value of the resistor 107 is set to 30Ω. All of power supply voltages applied to all of the power supply terminals 102, 110, and 113 are set to have the same voltage.

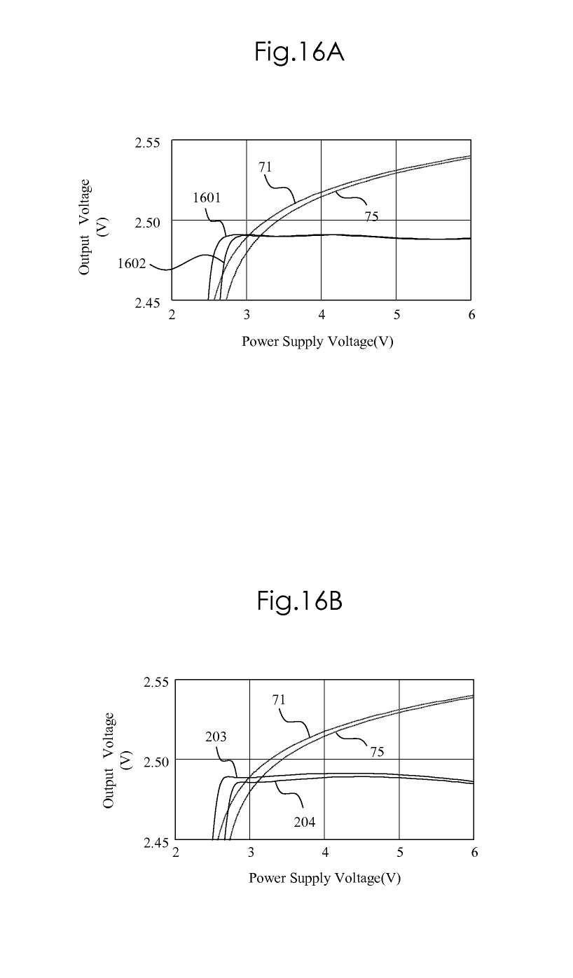

FIG. 16A is a diagram illustrating a relationship between an output voltage and a power supply voltage in the voltage generation circuit according to the present invention. FIG. 16B is a diagram illustrating the relationship between the output voltage and the power supply voltage in the voltage generation circuit illustrated in FIG. 1.

In FIG. 16A, a graph curve 1601 indicates a relationship between the output voltage and the power supply voltage of the voltage generation circuit 1501. A graph curve 1602 indicates a relationship between the output voltage and the power supply voltage of the voltage generation circuit 1501 when a current of 100 μA is drawn from the voltage output terminal 116. As the graph curve 71 for comparison, a graph indicating a relationship between the output voltage and the power supply voltage of the voltage generation circuit 51 in the related art is illustrated. As a graph curve 75, a graph curve indicating a relationship between the output voltage and the power supply voltage of the voltage generation circuit 51 when a current of 100 μA is drawn from the voltage output terminal 57 in the voltage generation circuit 51 of the related art is illustrated.

In FIG. 16B, the graph curve 203 indicates the relationship between the output voltage and the power supply voltage when the terminal 117 of the voltage generation circuit 101 is used as the voltage output terminal. The graph curve 204 indicates the relationship between the output voltage and the power supply voltage when a current of 100 μA is drawn from the voltage output terminal 117 of the same voltage generation circuit 101. Similarly to in FIG. 16A, in FIG. 16B, the graph curve 71 and the graph curve 75 are illustrated.

As illustrated in FIG. 16A, in the voltage generation circuit 1501, the output voltage becomes substantially constant in a range (wide power supply voltage range) in which the power supply voltage is higher than about 2.7 V, regardless of using the terminal 116 as the voltage output terminal.

As illustrated in FIG. 16B, in the voltage generation circuit 101, the output voltage (graph curve 204) when a current of 100 μA is drawn is smaller than the output voltage (graph curve 203) when a current is not drawn. As illustrated in FIG. 16A, in the voltage generation circuit 1501, the output voltage (graph curve 1601) when a current is not drawn and the output voltage (graph curve 1602) when a current of 100 μA is drawn are hardly changed (the graph curve 1601 is not lower than the graph curve 1602) in a range of the power supply voltage which is equal to or greater than about 2.9 V.

The voltage generation circuit 1501 has a configuration in which the resistor 111 is excluded from the voltage generation circuit 101. In this case, the action that the current flowing in the resistor 104 is decreased at the “timing when the collector current of the transistor 103 is started to flow” also occurs. This action occurs by the function of the resistor 1503 and the transistor 112, and the function of the resistors 107 and 115, and the transistor 114. Similarly showing of an effect of increasing the output voltage on the low power supply voltage region is described in the above-described embodiments.

This embodiment is used for describing that the output voltage can be caused to be constant in a wide power supply voltage range without using of combination with the component (resistor 62) of the voltage generation circuit 61 in the related art.

An operation of the voltage generation circuit 1501 according to the present invention will be described below. The resistor 1502 is a resistor for adjustment. Thus, if ignoring of the resistor 1502 is considered, the voltage generation circuit 1501 has a configuration in which the resistor 111 is omitted and an element value of each element is different in comparison to the voltage generation circuit 101.

Here, as illustrated in the graph curve 1004 of FIG. 10, a substantially constant current flows in the resistor 111 in a range of the power supply voltage which is equal to or greater than about 2.5 V. After the transistor 114 has the maximum value once, a current flows such that the current gradually decreases. In FIG. 10, as in the graph curve 1002, a current flows into the ground terminal as a current obtained by summing up both of the substantially constant current (graph curve 1004) of the resistor 111 and the current of the transistor 114.

In the voltage generation circuit 1501, adjustment is performed such that the maximum value of the current of the transistor 114 is moved to the low power supply voltage region, adjustment is performed such that the collector current is gradually decreased when the power supply voltage increases from about 2.6 V to about 6 V, and the resistor 111 in which a substantially constant current flows is omitted. Thus, setting is performed such that a change of the current of the transistor 114 by the transistor 109 is emphasized.

Since the resistor 115 is large and thus the collector current of the transistor 114 is gradually decreased and the current of the transistor 114 is decreased by the large resistor 115, the size of the transistor 114 is set to be large in the voltage generation circuit 1501. The emitter terminal of the transistor 112 is connected to a lower end of the resistor 107, that is, to the collector terminal of the transistor 108. Thus, the emitter current of the transistor 112 does not flow in the resistor 107 and decreasing of the base voltage of the transistor 108 more than necessary due to the voltage drop of the resistor 107 is prevented. Decreasing of the collector current of the transistor 114 more than necessary is prevented by preventing decreasing of the base voltage of the transistor 108 more than necessary. Adjustment is performed by causing the size of the transistor 112 to be large with the prevention, such that the base voltage of the transistor 114 increases at the “power supply voltage causing the current to be start to flow in the transistor 103”, that is, in the vicinity of the power supply voltage which is about 2.4 V to 2.5 V, and the collector current more increases. Thus, adjustment is performed such that the maximum value of the current of the transistor 114 is moved to the low power supply voltage region.

In the voltage generation circuit 1501, the base current of the transistor 108 is small and there is no current of the resistor 111. Thus, the emitter current of the transistor 109 is substantially equal to the collector current of the transistor 114 and the emitter current of the transistor 109 is changed so as to be the same as the collector current of the transistor 114. Accordingly, when the power supply voltage increases from about 2.6 V to about 6 V, the emitter current of the transistor 109 is gradually decreased and the base-emitter voltage of the transistor 109 gradually becomes small.

In the voltage generation circuit 1501, the voltage at the voltage output terminal 116 is a summation of the base-emitter voltage of the transistor 108 and the base-emitter voltage of the transistor 109. Accordingly, an “action of increasing the emitter current of the transistor 108 in accordance with the increase of the power supply voltage and then increasing the base-emitter voltage” is negated by performing the “action of gradually decreasing the base-emitter voltage of the transistor 109 in accordance with the increase of the power supply voltage”. Thus, adjustment so as to be the substantially constant output voltage may be considered.

Here, in the voltage generation circuit 1501, the current flowing in the resistor 1502 also gradually becomes small in accordance with the increase of the power supply voltage. Thus, an action that a potential difference between both terminals occurring due to the voltage drop in the resistor 1502 also gradually becomes small in accordance with the increase of the power supply voltage and the voltage at the voltage output terminal 116 is decreased in accordance with the increase of the power supply voltage occurs. The current flowing in the resistor 1502 and the emitter current of the transistor 109 are the same as each other. However, since a change of the voltage occurring between terminals of the resistor is different from a change of the voltage occurring between terminals of the transistor, in the same current change. Thus, adjustment of causing the output voltage to be flat by combination is preferably performed. In the voltage generation circuit 1501 of this embodiment, fine adjustment for the power supply voltage dependency is performed by setting the size of the transistor 109 to 1.5 times, and setting the resistor 1502 to 10Ω. Adjustment of causing the output voltage when the power supply voltage is 3 V to have the same value as in the voltage generation circuit 51 of the related art is performed by setting of the size of the transistor 108 to be 1.1 times.

As found from the comparison of FIG. 16A with FIG. 16B, an internal resistor of the voltage generation circuit 1501 seems to be lower than that in the voltage generation circuit 101 in which the terminal 117 is used as the voltage output terminal. That is, a state where decreasing of the output voltage is difficult occurs when a current is drawn from the voltage output terminal. This means that the current is drawn through the resistor 105 in order to use the terminal 117 as the voltage output terminal in the power source generation circuit 101. On the contrary, it is considered that there is a resistor corresponding to the resistor 105 for using the terminal 116 as the voltage output terminal in the voltage generation circuit 1501. As a result of examining the function of the circuit in detail, it is found that the function of the collector current of the transistor 114 has a relationship in addition to the presence or the absence of the resistor 105.

That is, the function of the transistors 112 and 114 is not performed directly by the change of the power supply voltage, but is performed by the collector current and the emitter current of the transistor 103, as described above. That is, a similar operation is also performed in a case where the current is drawn from the voltage output terminal and thus the collector current and the emitter current of the transistor 103 are relatively decreased.

Particularly, in the voltage generation circuit 1501, adjustment is performed such that the collector current of the transistor 114 is gradually decreased up to the power supply voltage of 6 V. Thus, an action of feedback in a direction in which the output voltage is increased with drawing of the current from the voltage output terminal occurs in the whole of the power supply voltage range up to 6 V.

In another circuit including the voltage generation circuit 101, when the resistor 111 is provided, an effect of a current change of the transistor 114 wears off by the current flowing in the resistor 111. Thus, showing of the effect is difficult or the collector current of the transistor 114 is decreased at once on the low power supply voltage region, and thus the above-described effect is limited only in the narrow power supply voltage range.

As described above, the configuration according to the present invention is a configuration significantly appropriate for combination with the configuration of the voltage generation circuit 61 in the related art. However, the combination with the configuration of the voltage generation circuit 61 in the related art is not a necessary condition. For example, as in the configuration (voltage generation circuit 1501) of this embodiment, even a resistor corresponding to the resistor 62 is not provided, it is possible to provide a voltage generation circuit having small power supply voltage dependency of the output voltage on a wide power supply voltage range. In the configuration (voltage generation circuit 1501) of this embodiment, it is possible to cause an action of causing the internal resistor to be small for a power source circuit to occur.

### Seventh Embodiment

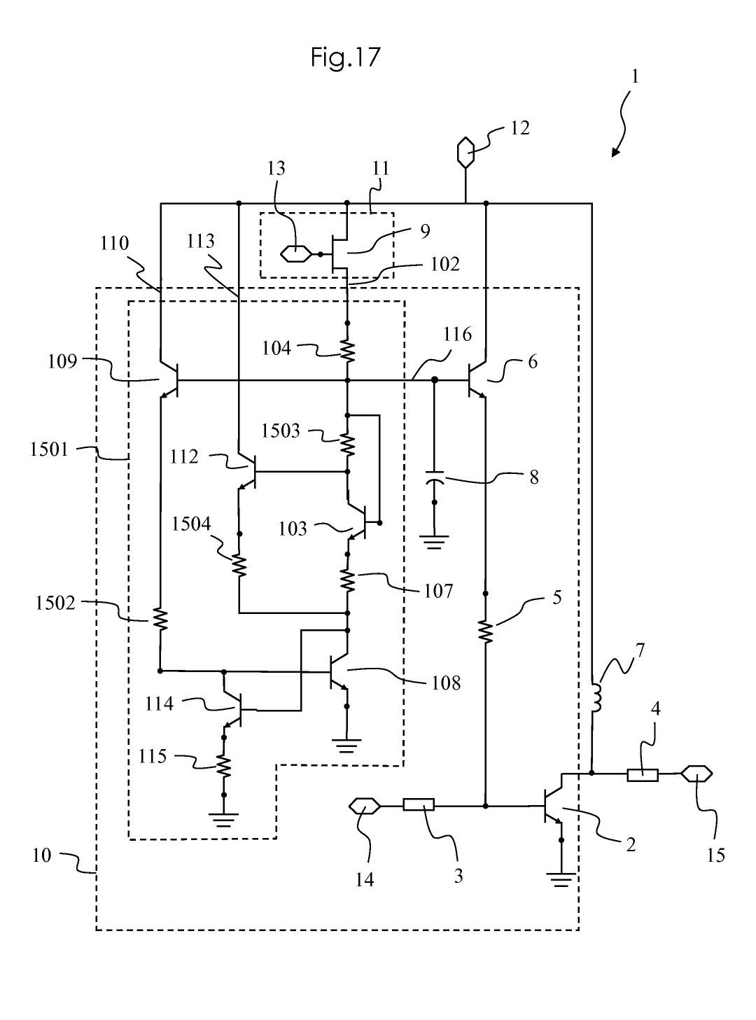

A high frequency power amplification circuit using the voltage generation circuit according to the present invention will be described with reference to the drawings. FIG. 17 is a diagram illustrating an example of the high frequency power amplification circuit using the voltage generation circuit according to the present invention.

As illustrated in FIG. 17, a high frequency power amplification circuit 1 includes an amplification transistor 2, an input matching circuit 3, an output matching circuit 4, a ballast resistor 5, and a bias transistor 6, a high frequency cutting choke coil 7, a high frequency cutting capacitor 8, a reference voltage source (voltage generation circuit) 1501, and a field effect transistor 9 for control. The high frequency cutting capacitor 8 prevents inputting of a high frequency signal to the voltage generation circuit.

Here, when a circuit surrounded by a dashed line 10 is configured as an integrated circuit by using hetero-junction bipolar transistors (NPN type bipolar transistors), a configuration according to the present invention, in which a PNP type element is not necessary, is important since normally, a transistor element is configured by only an NPN transistor.

Descriptions will be made below by using an example in which the field effect transistor 9 for control is configured as a portion of an integrated circuit 11 which is configured by normally-ON type hetero-junction field effect transistors. The hetero-junction field effect transistor is a general component which is much used as a high frequency switch circuit in a state of being adjacent to a high frequency amplification circuit.

The power supply voltage which has been applied to a power supply terminal 12 is applied to a collector terminal of the amplification transistor 2 through the choke coil 7. In the bias transistor 6, a collector terminal is connected to the power supply terminal 12, and a base terminal is connected to the voltage output terminal 116 of the voltage generation circuit 1501. A configuration in which a base current of the amplification transistor 2 is supplied via the ballast resistor 5 when a voltage of about 2.5 V is applied to the voltage output terminal 116 is obtained.

The field effect transistor 16 for control turns ON and OFF by a signal of a control terminal 13, and thus a voltage of the power supply terminal 102 in the voltage generation circuit 1501 is changed and an operation in the entirety of the circuit is controlled. A high frequency signal input from an input signal terminal 14 is amplified by the amplification transistor 2 via the input matching circuit 3, and then is output from an output signal terminal 15 via the output matching circuit 4.

Since a voltage applied to the power supply terminal 12 is supplied from a battery in a portable terminal and the like, the circuit has a necessity for performing a stable operation against fluctuation of the voltage. In addition, even when the power supply voltage is decreased by discharging of the battery, enabling of performing an operation with a voltage as low as possible is required.

In the related art, a constant voltage is generated in a regulator circuit and the like and a power amplification integrated circuit which is formed from hetero-junction bipolar transistors which are amplification elements is operated.

It is possible to provide a high frequency power amplification circuit in which a stable amplification operation against fluctuation of the voltage at the power supply terminal 12 is also enabled with a simple configuration in which the voltage at the power supply terminal 102 simply causes the field effect transistor 9 to turn ON and OFF, by using the voltage generation circuit according to the present invention, which has low power supply voltage dependency of the output voltage.

In the configuration of the voltage generation circuit in which the resistor 111 is not provided except for the circuit 1501 illustrated in FIG. 17 as in the circuits 1101 and 1301, using of a normally-ON type field effect transistor as the field effect transistor 9 is particularly appropriate. As described above, when the field effect transistor 9 for control is formed as a portion of the integrated circuit 11 including a high frequency switch and the like, the high frequency switch is normally configured by normally-ON type field effect transistors having a pinch-off voltage of about −0.5 V to −1.3 V. When this element is used for control, a “voltage obtained by multiplying the pinch-off voltage by −1”, that is, a voltage of about 0.5 V to 1.3 V is applied to the power supply terminal 102 even though a gate voltage is set to 0 V.

At this time, since there are two junction elements on a current path from a base terminal of the bias transistor 6 to the ground terminal via a base terminal of the amplification transistor 2, a current does not flow until a voltage of substantially two times a junction barrier of a junction element, here, a voltage of equal to greater than about 2.4 V is applied, and the circuit may be caused to turn OFF by using the above-described voltage (0.5 V to 1.3 V). At this time, if there are also two junction elements on the entirety of a current path to the ground terminal in the voltage generation circuit as in the circuit 1501, a current does not flow and an extra current when the circuit is OFF is not consumed. As in the voltage generation circuit 101, when the resistor 111 is provided, only one junction element (transistor 109) is included on a current path including the resistor 111. Thus, there is a case where the current flows a little. If process variations of the integrated circuit are considered, there is a case where a normally-OFF type field effect transistor which enables total blocking of a current flowing into the power supply terminal 102 may be used as the field effect transistor for control.

Here, when a battery is discharged and the power supply voltage is decreased to 3 V, even if a voltage of 1.7 V to 2.5 V is applied to a gate of the field effect transistor 9 for control, if the above normally-ON field effect transistor is used, an ON state occurs and thus a voltage of 3 V which is substantially the same as the power supply voltage may be applied to the power supply terminal 102.

When a normally-OFF field effect transistor (pinch-off voltage is in a range of 0.3 V to 0.5 V) is used as the field effect transistor 9 for control, even though a gate voltage is set to be the same as the power supply voltage of 3 V, a voltage applied to the power supply terminal 102 is in a range of 2.5 V to 2.7 V. In an integrated circuit configured by hetero-junction bipolar transistors (NPN bipolar transistors) in which about 2.5 V is required for the base voltage of the bias transistor 6, a voltage of about 2.7 V to 2.8 V is required as the lowest voltage, without the bias circuit according to the present invention. Thus, it is difficult to perform a stable operation with the above-described voltage.

It is possible to provide a high frequency amplification circuit in which a regulator circuit is unnecessary and control is enabled by simply performing ON/OFF of the power source, by using the voltage generation circuit according to the present invention. Particularly, it is possible to use a normally-ON type field effect transistor in control of the voltage generation circuit and to provide a high frequency amplification circuit in which performing of an operation is enabled with lower power supply voltage, by using the voltage generation circuit in which two or more junction elements are provided on the current path. In this embodiment, an example of a one-stage amplification circuit is described. However, similar configuration may be made in a multiple-stage amplification circuit.

Hitherto, the embodiments according to the present invention are described. However, the present invention is not limited to the details of the embodiments. Various modifications may be added to the embodiment according to the present invention in a range without departing from the gist of the invention.

### INDUSTRIAL APPLICABILITY

The present invention may be widely employed as a voltage supply source of an electronic circuit such as a portable phone and a communication device, which has a necessity that a voltage having low power dependency is supplied to the output voltage even though the power supply voltage fluctuates.

### REFERENCE SIGNS LIST

101 VOLTAGE GENERATION CIRCUIT
102 FIRST POWER SUPPLY TERMINAL
110, 113 POWER SUPPLY TERMINAL HAVING THE SAME POLARITY AS FIRST POWER SUPPLY TERMINAL
103 THIRD BIPOLAR TRANSISTOR
104 FIRST RESISTOR
105, 106, 107, 111, 115 RESISTOR
108 FIRST BIPOLAR TRANSISTOR
109 TRANSISTOR (SECOND CIRCUIT)
112 FOURTH BIPOLAR TRANSISTOR
114 SECOND BIPOLAR TRANSISTOR
116, 117 POWER OUTPUT TERMINAL
118 FIRST CIRCUIT
501 VOLTAGE GENERATION CIRCUIT
801 VOLTAGE GENERATION CIRCUIT
1101, 1102 VOLTAGE GENERATION CIRCUIT

1. A voltage generation circuit comprising:
a first power supply terminal; a voltage output terminal; a first resistor; a first bipolar transistor; a second bipolar transistor; a first circuit; and a second circuit,
wherein a first terminal of the first resistor is connected to the first power supply terminal,
an emitter terminal of the first bipolar transistor is connected to a ground terminal,
a first terminal of the first circuit is connected to a second terminal of the first resistor,
a second terminal of the first circuit is connected to a collector terminal of the first bipolar transistor,
the first circuit is one of
a circuit which has a diode and a resistor, and generates a voltage obtained by a summation of a forward junction voltage of diode junction and voltage drop due to the resistor, between the first terminal of the first circuit and the second terminal of the first circuit, in accordance with a diode current and
a circuit which has a bipolar transistor and a resistor, and generates a voltage obtained by a summation of a forward junction voltage of base-emitter junction and voltage drop due to the resistor, between the first terminal of the first circuit and the second terminal of the first circuit, in accordance with an emitter current,
a first terminal of the second circuit is connected to a second terminal of the first resistor,
a second terminal of the second circuit is connected to a base terminal of the first bipolar transistor,
the second circuit is one of
a circuit which has a diode, and generates a forward junction voltage of diode junction between the first terminal of the second circuit and the second terminal of the second circuit in accordance with a diode current and
a circuit which has a bipolar transistor, and generates a forward junction voltage of base-emitter junction between the first terminal of the second circuit and the second terminal of the second circuit in accordance with an emitter current,
an emitter terminal of the second bipolar transistor is connected to the ground terminal,
a collector terminal of the second bipolar transistor is connected to the base terminal of the first bipolar transistor,
a base terminal of the second bipolar transistor is connected to the second terminal of the first circuit,
the base-emitter junction of the first bipolar transistor and the base-emitter junction of the second bipolar transistor are connected in a forward direction for a potential at the first power supply terminal, and
the voltage output terminal is directly connected to the second terminal of the first resistor or is connected to the second terminal of the first resistor through a resistor.

2. The voltage generation circuit according to claim 1, further comprising:
a third bipolar transistor; and a fourth bipolar transistor,
wherein an emitter terminal of the third bipolar transistor is connected to the collector terminal of the first bipolar transistor,
a collector terminal and a base terminal of the third bipolar transistor are connected to each other on a first connection path,
a first connection terminal is provided on the first connection path,
the first connection terminal is connected to the second terminal of the first resistor,
a collector terminal of the fourth bipolar transistor is connected to one of the first power supply terminal and a power supply terminal having the same polarity as the first power supply terminal and at least some of resistive elements constituting the first resistor are not included on a path of connection,
an emitter terminal of the fourth bipolar transistor is connected to a connection path which connects the emitter terminal of the third bipolar transistor and the collector terminal of the first bipolar transistor,
a base terminal of the fourth bipolar transistor is connected to the first connection path between the first connection terminal and the collector terminal of the third bipolar transistor,
the first connection path has a resistor between the base terminal of the fourth bipolar transistor and the first connection terminal, and
a resistance value of the resistor on the first connection path between the base terminal of the fourth bipolar transistor and the first connection terminal is set so as to cause a base-emitter voltage of the fourth bipolar transistor to be lower than a base-emitter voltage of the third bipolar transistor.

3. A voltage generation circuit comprising:
a first power supply terminal; a voltage output terminal; a first resistor; a first bipolar transistor; a second bipolar transistor; a third bipolar transistor; a fourth bipolar transistor; and a second circuit,
wherein a first terminal of the first resistor is connected to the first power supply terminal,
an emitter terminal of the first bipolar transistor is connected to a ground terminal,
an emitter terminal of the third bipolar transistor is connected to a collector terminal of the first bipolar transistor,
a collector terminal and a base terminal of the third bipolar transistor are connected to each other on a first connection path,
a first connection terminal is provided on the first connection path,
the first connection terminal is connected to a second terminal of the first resistor,
a collector terminal of the fourth bipolar transistor is connected to one of the first power supply terminal and a power supply terminal having the same polarity as the first power supply terminal and at least some of resistive elements constituting the first resistor are not included on a path of connection,
an emitter terminal of the fourth bipolar transistor is connected to a connection path which connects the emitter terminal of the third bipolar transistor and the collector terminal of the first bipolar transistor,
a base terminal of the fourth bipolar transistor is connected to the first connection path between the first connection terminal and the collector terminal of the third bipolar transistor,
the first connection path has a resistor between the base terminal of the fourth bipolar transistor and the first connection terminal,
a resistance value of the resistor on the first connection path between the base terminal of the fourth bipolar transistor and the first connection terminal is set so as to cause a base-emitter voltage of the fourth bipolar transistor to be lower than a base-emitter voltage of the third bipolar transistor,
a first terminal of the second circuit is connected to a second terminal of the first resistor,
a second terminal of the second circuit is connected to a base terminal of the first bipolar transistor,
the second circuit is one of
a circuit which has a diode, and generates a forward junction voltage of diode junction between the first terminal of the second circuit and the second terminal of the second circuit in accordance with a diode current and
a circuit which has a bipolar transistor, and generates a forward junction voltage of base-emitter junction between the first terminal of the second circuit and the second terminal of the second circuit in accordance with an emitter current,
the base-emitter junction of the first bipolar transistor, the base-emitter junction of the third bipolar transistor, and the base-emitter junction of the fourth bipolar transistor are connected in a forward direction for a potential at the first power supply terminal, and
the voltage output terminal is directly connected to the second terminal of the first resistor or is connected to the second terminal of the first resistor through a resistor.

4. A voltage generation circuit comprising:
a first power supply terminal; a voltage output terminal; a first resistor; and a first diode,
wherein a first terminal of the first resistor is connected to the first power supply terminal,
a first terminal of the first diode is connected to a ground terminal,
an emitter terminal of a third bipolar transistor is connected to a second terminal of the first diode,
a collector terminal and a base terminal of the third bipolar transistor are connected to each other on a first connection path,
a first connection terminal is provided on the first connection path,
the first connection terminal is connected to a second terminal of the first resistor,
a collector terminal of a fourth bipolar transistor is connected to one of the first power supply terminal and a power supply terminal having the same polarity as the first power supply terminal and at least some of resistive elements constituting the first resistor are not included on a path of connection,
an emitter terminal of the fourth bipolar transistor is connected to a connection path which connects an emitter terminal of the third bipolar transistor and a collector terminal of a first bipolar transistor,
a base terminal of the fourth bipolar transistor is connected to the first connection path between the first connection terminal and a collector terminal of the third bipolar transistor,
the first connection path has a resistor between the base terminal of the fourth bipolar transistor and the first connection terminal,
a resistance value of the resistor on the first connection path between the base terminal of the fourth bipolar transistor and the first connection terminal is set so as to cause a base-emitter voltage of the fourth bipolar transistor to be lower than a base-emitter voltage of the third bipolar transistor,
diode junction of the first diode, base-emitter junction of the third bipolar transistor, and base-emitter junction of the fourth bipolar transistor are connected in a forward direction for a potential at the first power supply terminal, and
the voltage output terminal is directly connected to the second terminal of the first resistor or is connected to the second terminal of the first resistor through a resistor.
